(19) United States
(12) Patent Application Publication
(10) Pub. No.: US 2018/0341423 A1
(43) Pub. Date: Nov. 29, 2018

(54) STORAGE CONTROL DEVICE AND INFORMATION PROCESSING SYSTEM

(71) Applicant: FUJITSU LIMITED, Kawasaki-shi (JP)

(72) Inventor: Akira Hori, Nissin (JP)

(73) Assignee: FUJITSU LIMITED, Kawasaki-shi (JP)

(21) Appl. No.: 15/983,574

(22) Filed: May 18, 2018

(30) Foreign Application Priority Data
May 23, 2017 (JP) 2017-101984

(51) Int. Cl. G06F 3/06

(52) U.S. Cl. CPC G06F 3/0647; G06F 3/0685; G06F 3/0653; G06F 3/0611

(57) ABSTRACT

A storage control device includes a memory and a processor coupled to the memory. The memory is configured to store ranking information indicative of respective rankings of data blocks determined based on evaluation of an access situation of the data blocks. The data blocks are located in memory devices having different access performances and classified into layers depending on respective access performances of the memory devices. The processor is configured to determine, when a change of layer configuration accompanying a relocation of a first data block between layers is performed, a destination memory device to which the first data block is relocated based on the ranking information stored in the memory. The processor is configured to relocate the first data block to the destination memory device.

### CROSS-REFERENCE TO RELATED APPLICATION

This application is based upon and claims the benefit of priority of the prior Japanese Patent Application No. 2017-101984, filed on May 23, 2017, the entire contents of which are incorporated herein by reference.

### FIELD

The embodiments discussed herein are related to a storage control device and an information processing system.

### BACKGROUND

Storage devices have been used to store data. Storage devices are equipped with a plurality of memory devices such as a hard disk drive (HDD) and a solid state drive (SSD) so as to enable a large-volume storage area to be used. The storage device is connected to a storage control device that performs an access control for writing and reading data to and from the memory devices. The storage device may incorporate the storage control device.

Herein, there is known a technique called storage tiering to classify the memory devices provided in the storage device into layers depending on a response performance and rearrange data between layers (tiers). For example, a system that performs storage tiering includes a management server that collects information on an access status for each piece of data. The management server instructs the storage control device to rearrange the data between the layers in accordance with evaluation of the access status for each piece of data. The storage control device performs a relocation of data between the layers according to the instruction. The data relocation is performed, for example, per block (referred to as a data block) of a predetermined size. The management server increases a data access speed by arranging data with a high access frequency in a high-speed storage device such as, for example, the SSD. Meanwhile, the management server reduces the data storage cost by arranging data with a low access frequency in a low-speed memory device such as, for example, the HDD.

Various techniques are being considered for classifying the memory devices into layers. For example, there is suggested a storage tiering method for classifying and managing each SSD in a plurality of different tiers (layers) according to the performance of each SSD in the storage device including a plurality of SSDs. Further, there is also suggested a storage device that efficiently utilizes an internal memory area by preferentially removing (e.g., reducing) the design of an external memory area when a predetermined tier in a pool composed of one or more logical volumes including the internal storage area and the external storage area is reduced.

Related techniques are disclosed in, for example, International Publication Pamphlet No. WO 2015/029102 and Japanese Laid-Open Patent Publication No. 2013-114624.

### SUMMARY

According to an aspect of the present invention, provided is a storage control device including a memory and a processor coupled to the memory. The memory is configured to store ranking information indicative of respective rankings of data blocks determined based on evaluation of an access situation of the data blocks. The data blocks are located in memory devices having different access performances and classified into layers depending on respective access performances of the memory devices. The processor is configured to determine, when a change of layer configuration accompanying a relocation of a first data block between layers is performed, a destination memory device to which the first data block is relocated based on the ranking information stored in the memory. The processor is configured to relocate the first data block to the destination memory device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage control device according to a first embodiment;

FIG. 2 is a diagram illustrating an information processing system according to a second embodiment;

FIG. 3 is a diagram illustrating an example of hardware of a storage device;

FIG. 4 is a diagram illustrating an example of hardware of a management server;

FIG. 5 is a diagram illustrating an example of a shrink function of AST;

FIG. 6 is a diagram illustrating a functional example of the information processing system;

FIG. 7 is a diagram illustrating an example of a bit string (FTRPE individual information);

FIG. 8 is a diagram illustrating an example of a volume management table;

FIG. 9 is a diagram illustrating an example of an allocation management table;

FIG. 10 is a diagram illustrating examples of an access frequency table and an evaluation information management table;

FIG. 11 is a flowchart illustrating an example of layer configuration change control processing of a management server;

FIG. 12 is a flowchart illustrating an example of layer configuration change processing of a CM;

FIG. 13 is a flowchart illustrating an example of information collection processing of the management server;

FIG. 14 is a flowchart illustrating an example of information providing processing of the CM;

FIG. 15 is a flowchart illustrating an example of AST object decision processing of the management server;

FIG. 16 is a flowchart illustrating an example of relocation processing of the CM;

FIG. 17 is a flowchart illustrating an example of ranking evaluation processing of the management server;

FIG. 18 is a flowchart illustrating an example of bit string update process of the CM;

FIG. 19 is a flowchart illustrating an example of progress confirmation processing of the management server;

FIG. 20 is a diagram illustrating a specific example of relocation processing by AST;

FIG. 21 is a diagram illustrating a specific example of relocation processing at the time of executing a shrink function; and

FIG. 22 is a diagram illustrating an updating example of an evaluation information management table based on history information.

### DESCRIPTION OF EMBODIMENTS

The storage control device may change a layer configuration (e.g., adding or removing a layer). Changing the layer configuration may accompany a relocation of data blocks from a predetermined layer to a separate layer. For example, when the layer is removed, the storage control device relocates the data blocks of the layer that is a target to be removed in a memory device of a layer that is not a target to be removed.

In this case, it is conceivable that the storage control device determines a relocation destination of the data block based on a use capacity (e.g., a predetermined capacity ratio for each type of memory device) of the memory device in each layer. However, in such a criterion, an access status for each data block by storage tiering is not considered. For this reason, for example, a data block with a relatively high access frequency may be arranged in a low-speed memory device, or, a data block with a relatively low access frequency may be arranged in a high-speed memory device. Then, with respect to the rearranged data block, the data arrangement considering the access situation by storage tiering is damaged and access performance to the corresponding data block may deteriorate.

Hereinafter, embodiments of the present invention will be described with reference to the drawings.

### First Embodiment

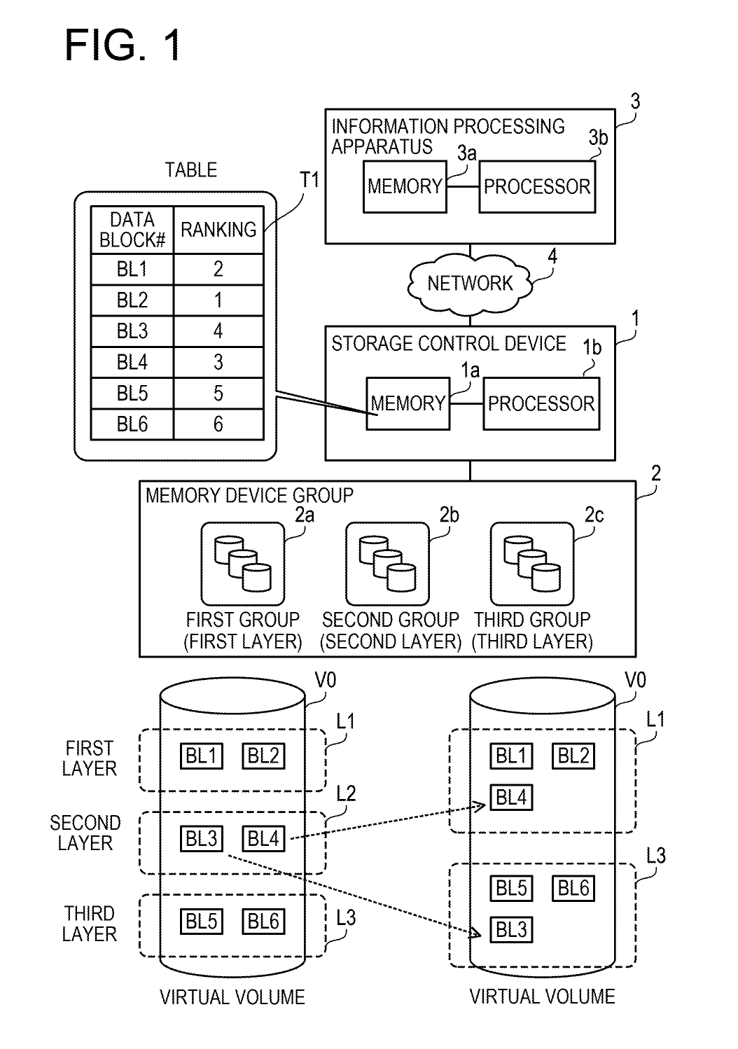

FIG. 1 is a diagram illustrating a storage control device according to a first embodiment. A storage control device 1 controls the access to a plurality of memory devices belonging to a memory device group 2. The memory device group 2 is an aggregate of the plurality of memory devices and is incorporated in an enclosure that houses the plurality of memory devices. The storage control device 1 and the corresponding enclosure are connected by a predetermined cable.

The memory device group 2 includes a plurality of types of memory devices each having different access performances from each other. A first type of storage device belongs to a first group 2a. A second type of memory device belongs to a second group 2b. A third type of memory device belongs to a third group 2c.

The first type of storage device is, for example, an SSD. The second type of memory device is, for example, an online disk. The third type of memory device is, for example, a nearline disk. Herein, the “disk” may be referred to as, for example, an HDD, or a magnetic disk device. In this case, among three types of memory devices, the first type of memory device has the highest access speed. The second type of memory device has the second highest access speed among three types. The third type of memory device has the lowest access speed among three types of memory devices.

The storage control device 1 manages the first group 2a, the second group 2b, and the third group 2c to correspond to the layers (tiers), respectively. For example, the first group 2a corresponds to a first layer L1. The second group 2b corresponds to a second layer L2. The third group 2c corresponds to a third layer L3. According to such a correspondence relationship, a physical memory area belonging to the first group 2a belongs to the first layer L1. The physical memory area belonging to the second group 2b corresponds to the second layer L2. The physical memory area belonging to the third group 2c belongs to the third layer L3.

The storage control device 1 provides a virtual volume V0 by using the physical memory areas belonging to the first layer L1, the second layer L2, and the third layer L3. The virtual volume V0 is a logical memory area used by a user. The virtual volume V0 has a plurality of data blocks. The data block is one unit (a unit of the logical memory area) of the memory area in the virtual volume V0. For example, the virtual volume V0 has data blocks BL1, BL2, BL3, BL4, BLS, and BL6.

One data block corresponds to any one of physical memory areas which belong to the first layer L1, the second layer L2, and the third layer L3. The storage control device 1 holds information indicating the correspondence relationship between the data block and the physical memory area. For example, when a predetermined data block is allocated to the physical memory area belonging to the first layer, the corresponding data block may be classified into the first layer. Alternatively, the corresponding data block may be located in the memory device belonging to the first layer.

The storage control device 1 may change the division of the data block from a predetermined layer to a separate layer by changing the correspondence relationship between the data block and the physical memory area (also by actually moving the data block). The change of the division of the data block may also be referred to as relocation of the data block from a predetermined layer to a separate layer. Further, the change of the division of the data block may be relocation of data stored in the memory area corresponding to the corresponding data block from a predetermined layer to a separate layer.

In an example, it is considered that the storage control device 1 may control so as to change the division of the data block having a relatively high access frequency to a layer having a higher access performance according to a predetermined policy. As a result, it is possible to shorten a response time to data having the high access frequency. Meanwhile, it is considered that the storage control device 1 controls to change the division of the data block having a relatively low access frequency to a layer having a lower access performance according to the predetermined policy. As a result, it is possible to reduce storage cost of the data. Such control may be referred to as automated storage tiering (AST) or storage tiering.

For example, an information processing apparatus 3 that manages the access frequency for each data block is installed. The information processing apparatus 3 is connected to the storage control device 1 via a network 4. The information processing apparatus 3 instructs the storage control device 1 to change the division of the data block from a predetermined layer to a separate layer via the network 4. In this case, the storage control device 1 changes the division of the data block from a predetermined layer to a separate layer according to the instruction of the information processing apparatus 3. The information processing apparatus 3 may hold information on an allocation relationship of a plurality of virtual volumes and the physical memory area for each virtual volume, and execute the AST for each virtual volume.

Here, due to the operation of the system, the layer configuration of the memory device group 2 may be changed. Changing the layer configuration is, for example, adding a new layer or removing an existing layer. Herein, the removal refers to removal (an opposite meaning to addition). Changing the layer configuration may accompany a relocation of the data blocks between the layers. For example, in the case of removing the existing layer, the data blocks belonging to the layer to be removed are rearranged in the layer to be not removed. Therefore, the storage control device 1 provides a function of appropriately determining a relocation destination at this time and performing the relocation.

The storage control device 1 includes a memory 1a and a processor 1b.

The memory 1a may be a volatile memory device such as, for example, a random access memory (RAM) or a non-volatile memory device such as an HDD or a flash memory. The processor 1b may include, for example, a central processing unit (CPU), a digital signal processor (DSP), an application specific integrated circuit (ASIC), and a field programmable gate array (FPGA). The processor 1b may be a processor that executes a program. The “processor” may also include an aggregate (multiprocessor) of a plurality of processors.

For each of the plurality of data blocks, the memory 1a stores information on ranking related to evaluation of a predetermined access situation. Here, as described above, one data block is located in one memory device. That is, the plurality of data blocks is located in a plurality of memory devices having different access performances. Further, as described above, the plurality of data blocks is classified into a plurality of layers according to the access performance of the memory device of the location destination.

For example, the memory 1a stores a table T1. The table T1 is an example of the ranking information for each of the plurality of data blocks. Further, herein, although an example of holding the ranking information is illustrated in the table T1, storing the information of each ranking in the memory 1a in a part of the physical memory area where each data block is located may be considered as loading the information of each ranking to the memory 1a by the processor 1b.

The table T1 includes data block numbers (denoted as data block # using sharp symbol “#”) and ranking items. The data block # is the identification information of the data block. The ranking is the ranking of each data block in all of the plurality of data blocks according to the evaluation of the predetermined access situation for each data block. For example, the access situation is the access frequency. Alternatively, the evaluation of the access situation may be, for example, an evaluation of a result of adding the access frequency according to a specification of the memory devices belonging to each layer. As an example, when evaluating the access frequency, the higher the access frequency, the higher the ranking. Herein, it is assumed that the smaller the number representing the ranking is, the higher the ranking is. The ranking information may be the evaluation result for the AST by the information processing apparatus 3 (that is, the ranking information in the table T1 may be acquired from the information processing apparatus 3). In addition, the evaluation of the access situation may be, for example, a performance evaluation such as inputs/outputs per second (IOPS: the number of I/O accesses which the disk may process per second) (where “IOPS” is used as a word expressing the access frequency).

Here, in the following description, the data block of data block # “X” is represented as data block X.

According to an example of the table T1, the rankings of each of the data blocks BL1, BL2, BL3, BL4, BL5, and BL6 is as follows. The ranking of the data block BL1 is “2.” The ranking of the data block BL2 is “1.” The ranking of the data block BL3 is “4.” The ranking of the data block BL4 is “3.” The ranking of the data block BL5 is “5.” The ranking of the data block BL6 is “6.” This indicates that the access frequency is high in the order of, for example, the data blocks BL2, BL1, BL4, BL3, BL5, and BL6.

Herein, in an example, it is assumed that it is predetermined that the storage capacity is evenly allocated to each layer as the policy of the layer configuration for the virtual volume V0. In accordance with the policy, for example, the data blocks BL1, BL2, BL3, BL4, BL5, and BL 6 are classified into respective layers as follows. The data blocks BL1 and BL2 are classified into the first layer L1. The data blocks BL3 and BL4 are classified into the second layer L2. The data blocks BL5 and BL6 are classified into the third layer L3.

When changing the layer configuration accompanying the relocation of the data blocks between the layers, the processor 1b determines the memory device of the relocation destination of the data block to be relocated based on the ranking information stored in the memory 1a. The processor 1b relocates the data block in the determined memory device of the relocation destination.

For example, as an example of the change of the layer configuration accompanying the relocation of the data blocks between the layers, the removal of the layer is considered. More specifically, it is considered that the second layer L2 is removed from the existing first layer L1, second layer L2, and third layer L3 (for example, when canceling the group of the second group 2b)

In this case, the processor 1b identifies the data blocks BL3 and BL4 classified into the second layer L2 to be removed as a relocation target. In addition, the processor 1b determines the memory device of the relocation destination of the data blocks BL3 and BL 4 as the relocation targets based on the table T1 stored in the memory 1a. Specifically, according to the table T1, the ranking of the data block BL3 is “4.” Further, the ranking of the data block BL4 is “3.” That is, an upper half of the data blocks BL3 and BL4 is the data block BL4 and a lower half thereof is the data block BL3.

Therefore, the processor 1b determines the memory device belonging to the first layer L1 as the relocation destination of the data block BL4. Therefore, the processor 1b determines the memory device belonging to the third layer L3 as the relocation destination of the data block BL3. Further, when there is a plurality of relocation destination candidate storage devices belonging to a predetermined layer, the processor 1b selects the relocation destination according to a predetermined criterion such as, for example, preferentially selecting a memory device having a higher available storage capacity among the plurality of respective relocation destination candidate memory devices.

The processor 1b relocates the data block BL4 in the memory device belonging to the first layer L1 determined as the relocation destination. As a result, the data block BL4 is classified into the first layer L1. In addition, the processor 1b relocates the data block BL3 in the memory device belonging to the third layer L3 determined as the relocation destination. As a result, the data block BL3 is classified into the third layer L3.

When the relocation of the data blocks BL3 and BL4 classified into the second layer L2 is completed, the processor 1b performs the removal of the second layer L2.

As a result, the storage control device 1 may suppress the deterioration of the access performance by the data relocation at the time of changing the layer configuration. Specifically, the suppressing will be described below.

For example, the relocation of the data blocks accompanied by the change in layer configuration is executed by a function of the storage control device side. In this case, it is also considered that the storage control device performs the relocation of the data blocks accompanied by the change in layer configuration regardless of the information (access situation) corresponding to the table T1. However, when the storage control device 1 relocates the data blocks while not determining the information such as, for example, the access frequency for each data block, an inappropriate relocation may be performed.

Specifically, it is considered that when the types of the memory devices are different (regardless of the evaluation result of the access situation), the storage control device relocates the data blocks so that a storage capacity of the memory device increases in the order of the online disk, the nearline disc, and the SSD. Alternatively, it is also considered that the data blocks are relocated only with the criterion to equalize the storage capacities of the memory devices of the respective layers. In these methods, for example, when an intermediate (middle) layer is deleted, a data block with a low access frequency may be relocated in the SSD. Further, on the contrary, the data blocks with the high access frequency may be relocated in the nearline disk.

Such inappropriate relocation becomes a cause for lowering the access performance to the data block with the high access frequency. Further, inappropriate relocation becomes a cause for extra use of the memory area of the memory device having the high access performance by the data block having the low access frequency. It is more efficient to suppress the inappropriate relocation in advance than to correct the inappropriate relocation by subsequent automated storage tiering (AST).

Therefore, the processor 1b determines the relocation destination of the data block accompanied by the change of the layer configuration according to the ranking corresponding to the access situation of each of the plurality of data blocks and relocates the data block in the determined relocation destination. As a result, for example, the processor 1b may appropriately relocate the data block having the relatively high access frequency in the memory device of the first layer L1 among the data blocks as the relocation target and the data block having the relatively low access frequency in the memory device of the third layer L3, respectively. That is, for example, it is possible to suppress inappropriate relocation such as relocation of the data block having the low access frequency in the SSD or relocation of the data block having the high access frequency in the nearline disk. Thus, the storage control device 1 may suppress the deterioration of the access performance by the data relocation at the time of changing the layer configuration.

As described above, the information of the ranking according to the access situation of each data block may be created by the information processing apparatus 3. For example, the information processing apparatus 3 has a memory 3a and a processor 3b. The memory 3a may be a volatile memory device such as, for example, a random access memory (RAM) or a non-volatile memory device such as an HDD or a flash memory. The processor 3b may include, for example, a CPU, a DSP, an ASIC, and an FPGA. The processor 3b may be the processor that executes the program. The “processor” may also include the aggregate (multiprocessor) of the plurality of processors.

For example, it is considered that there is a plurality of sets of the storage control device 1 and the memory device group 2. In this case, the processor 3b collects, from each of the plurality of storage control devices, information such as the access frequency to the data block to which each of the plurality of storage control devices is in charge of access and stores the information in the memory 3a. In addition, the processor 3b determines the ranking of each data block among all of the data blocks based on the information (information collected from each storage control device) stored in the memory 3a. In addition, the processor 3b provides the determined ranking of each data block to each storage control device.

In this case, for example, the processor 1b stores the information on the ranking acquired from the information processing apparatus 3 in a predetermined area of the corresponding data block which the processor 1b is in charge of accessing. In one data block, the ranking of the data block with respect to all of the data blocks under the plurality of storage control devices is stored. In addition, when changing the layer configuration, the processor 1b loads the ranking information from each data block to the memory 1a. When changing the layer configuration, the processor 1b loads only the ranking information of the data block as the relocation target.

By acquiring the ranking information from the information processing apparatus 3, the processor 1b ends without calculating the ranking of each data block by itself. Therefore, there is also an advantage that a load of the processor 1b may be reduced. In addition, the processor 1b may perform a control matched with the AST by the information processing apparatus 3 by using the evaluation result of the access situation in the AST by the information processing apparatus 3 even in the processing of changing the layer configuration by the storage control device 1.

The processor 1b may record, for each data block, the layer before relocation and the layer after relocation with respect to the data block to be relocated due to the change in layer configuration, and transmit the layers to the information processing apparatus 3. In this way, it is possible to change the layer for each data block managed by the information processing apparatus 3 to the layer after relocation by the storage control device 1. As a result, the information processing apparatus 3 may appropriately manage the layer after relocation of each data block. Therefore, the information processing apparatus 3 may continuously perform the AST by taking over the evaluation result of the access frequency for each movement determination target data unit (FTRPE: flexible tier pool element) to an upper layer performed before the relocation even after the relocation. As a result, the information processing apparatus 3 may not perform the AST from collection of the access situation of the FTRPE again and continuously operate the AST without stopping the AST.

### Second Embodiment

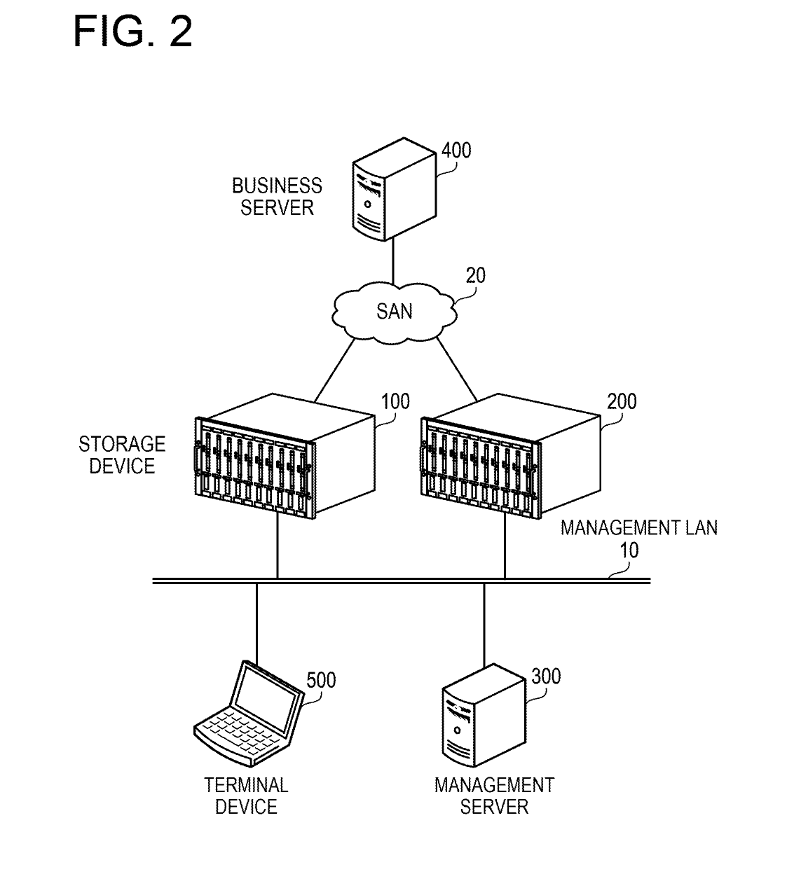

FIG. 2 is a diagram illustrating an information processing system according to a second embodiment. The information processing system according to the second embodiment includes storage devices 100 and 200 and a management server 300. The storage devices 100 and 200 and the management server 300 are connected to a management local area network (LAN) 10. In addition, the storage devices 100 and 200 are also connected to a storage area network (SAN) 20. A business server 400 is connected to the SAN 20. A terminal device 500 is connected to the management LAN 10.

The storage device 100 controls an access by the business server 400 to a virtual logical volume (simply referred to as a virtual volume) provided by the storage device 100. Similarly, the storage device 200 also controls the access by the business server 400 to the virtual volume provided by the storage device 200. The storage devices 100 and 200 include a plurality of types of memory devices having different access performances such as the SSD, the on-line disk, and the near-line disk. The storage devices 100 and 200 combine a unit area (called a data block, block or logical block) of a predetermined size in the plurality of types of memory devices to construct the virtual volume and provide the virtual volume to the business server 400.

The management server 300 is a server computer that manages the operation of the storage devices 100 and 200. For example, the management server 300 performs the AST for the storage devices 100 and 200. The AST is a function of managing the memory device in a pool for each type and relocating each piece of data in the storage device in an appropriate memory device per block smaller than a volume capacity according to the access situation, thereby making the performance and cost compatible properly with each other.

The business server 400 is a server computer that accesses the logical volumes provided by the storage devices 100 and 200 and executes business processing using the data stored in the logical volumes.

The terminal device 500 is a client computer used by an administrator of the information processing system. For example, the terminal device 500 provides the administrator with a graphical user interface (GUI) or a command line interface (CLI) for receiving input of commands to the storage devices 100 and 200. The terminal device 500 inputs the received commands in the storage devices 100 and 200. The terminal device 500 displays contents of responses from the storage devices 100 and 200 according to the commands, thereby providing the contents of the responses to the administrator.

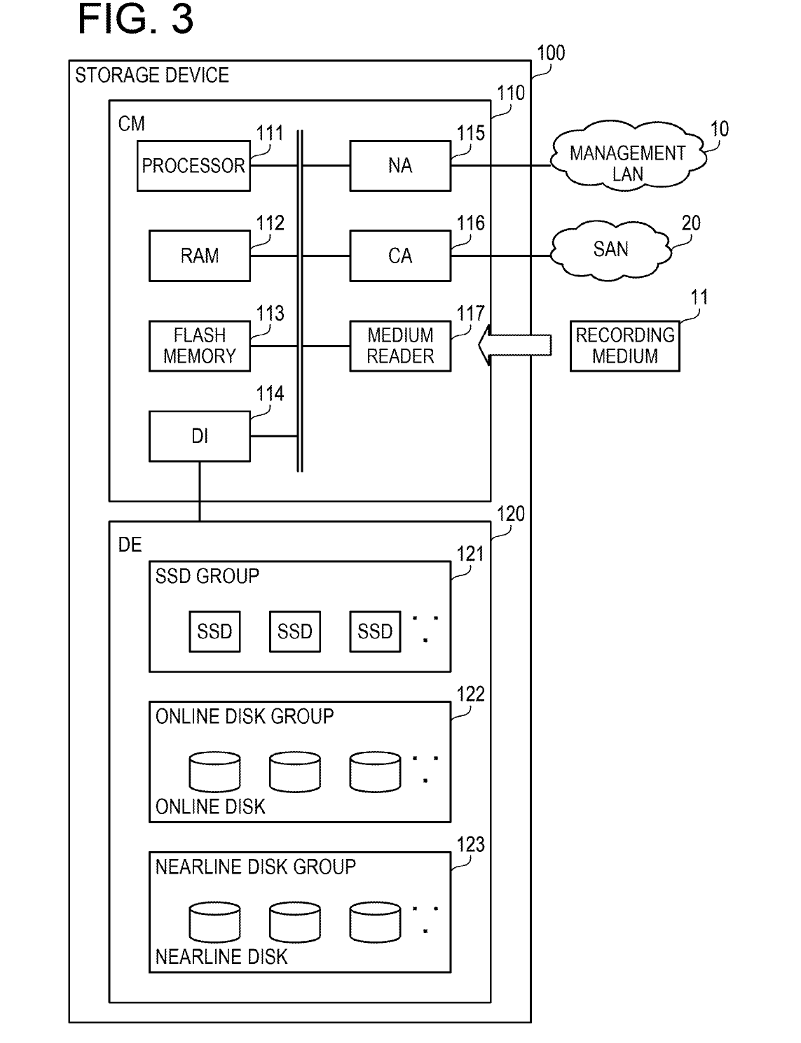

FIG. 3 is a diagram illustrating an example of hardware of a storage device. The storage device 100 includes a controller module (CM) 110 and a disk enclosure (DE) 120. Further, the storage device 100 may include two or more CMs.

The CM 110 is a storage control device that accesses the memory device in the DE 120 according to an access request from the business server 400. Further, the CM 110 relocates the blocks according to the AST in accordance with an instruction from the management server 300. For example, in accordance with the instruction from the management server 300, the CM 110 relocates (moves) the blocks included in the virtual volume from the memory device in the DE 120 to a separate memory device.

The DE 120 has a plurality of memory devices for storing business data used for business processing of the business server 400. The DE 120 has memory devices with different access performances. Specifically, the DE 120 has the SSD, the online disk, and the nearline disk. Among them, the SSD has the highest access performance. The online disk has the second highest access performance. The nearline disk has the lowest access performance.

The CM 110 has a processor 111, a RAM 112, a flash memory 113, a drive interface (DI) 114, a network adapter (NA) 115, a channel adapter (CA) 116, and a medium reader 117. Each piece of hardware is connected to a bus of the CM 110.

The processor 111 is hardware for controlling information processing of the CM 110. The processor 111 is, for example, the CPU, the DSP, the ASIC, or the FPGA. The processor 111 may be the multiprocessor. The processor 111 may be, for example, a combination of two or more elements including the CPU, the DSP, the ASIC, and the FPGA.

The RAM 112 is a main memory device of the CM 110. The RAM 112 temporarily stores at least a part of the program of firmware executed by the processor 111. Further, the RAM 112 stores various data used for the processing by the processor 111.

The flash memory 113 is a sub memory device of the CM 110. The flash memory 113 is a non-volatile memory device that electrically writes data to a built-in memory element. The flash memory 113 stores firmware programs and various data.

A DI 114 is a communication interface for connecting with the DE 120. As the DI 114, for example, a serial attached SCSI (however, SCSI is an abbreviation of small computer system interface) may be used.

An NA 115 is the communication interface for connecting with the management LAN 10. As the NA 115, for example, the interface of Ethernet (registered trademark) may be used.

A CA 116 is the communication interface for connecting with the SAN 20. As the CA 116, for example, an interface such as fibre channel (FC), fibre channel over Ethernet (FCoE) (Ethernet is a registered trademark) or small computer system interface over Internet protocol (iSCSI) may be used.

The medium reader 117 is a device that reads the program or data recorded on the recording medium 11. As the recording medium 11, for example, a non-volatile semiconductor memory such as a flash memory card may be used. The medium reader 117, for example, stores the program or data read from the recording medium 11 in the RAM 112 or the flash memory 113 according to the command from the processor 111.

The DE 120 has an SSD group 121, an online disk group 122 and a nearline disk group 123. The SSD group 121 includes a plurality of SSDs. For example, the online disk group 122 includes a plurality of online disks (online HDDs). The nearline disk group 123 includes a plurality of nearline disks (nearline HDDs).

A plurality of same types of memory devices constitutes redundant arrays of inexpensive disk (RAID) group. For example, the SSD group 121 may include a plurality of RAID groups by the SSD. Further, the online disk group 122 may include the plurality of RAID groups by the online disk. In addition, the nearline disk group 123 may include the plurality of RAID groups by the nearline disk. In this case, the block allocated to the virtual volume is a memory area belonging to any one RAID group.

The storage device 200 may also be implemented by the same hardware as the storage device 100. That is, the storage device 200 has the CM and the DE. As in the DE 120, the DE of the storage device 200 also has the SSD group, the online disk group, and the nearline disk group.

The CM 110 is an example of the storage control device 1 according to the first embodiment and the drive group stored in the DE 120 is an example of the memory device group 2 according to the first embodiment.

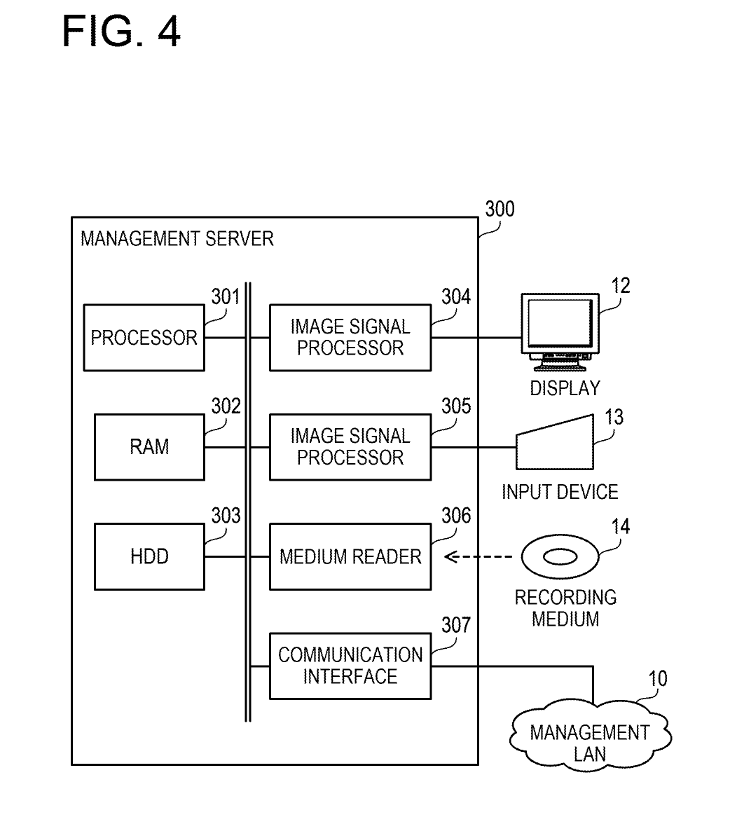

FIG. 4 is a diagram illustrating an example of hardware of a management server. The management server 300 includes a processor 301, a RAM 302, an HDD 303, an image signal processor 304, an input signal processor 305, a medium reader 306, and a communication interface 307.

The processor 301 is hardware for controlling information processing of the management server 300. The processor 301 may be the multiprocessor. The processor 301 is, for example, the CPU, the DSP, the ASIC, or the FPGA. The processor 301 may be, for example, a combination of two or more elements among the CPU, the DSP, the ASIC, and the FPGA.

The RAM 302 is the main memory device of the management server 300. The RAM 302 temporarily stores at least a part of the program of an operating system (OS) or an application program executed in the processor 301. Further, the RAM 302 stores various data used for the processing by the processor 301.

The HDD 303 is the sub memory device of the management server 300. The HDD 303 magnetically writes and reads data to and from a built-in magnetic disk. The HDD 303 stores the OS programs, the application programs, and various data. The management server 300 may include other types of sub memory devices such as the flash memory or SSD or may include a plurality of sub memory devices.

The image signal processor 304 outputs an image to the display 12 connected to the management server 300 according to the command from the processor 301. As for the display 12, for example, a cathode ray tube (CRT) display, or a liquid crystal display may be used.

The input signal processor 305 acquires an input signal from an input device 13 connected to the management server 300 and outputs the acquired input signal to the processor 301. As the input device 13, for example, a pointing device such as a mouse or a touch panel, or a keyboard may be used.

The medium reader 306 is the device that reads the program or data written in the recording medium 14. As the recording medium 14, for example, a magnetic disk such as a flexible disk (FD) or HDD, an optical disk such as a compact disk (CD) or a digital versatile disk (DVD), a magneto-optical disk (MO) may be used. Further, as the recording medium 14, for example, the non-volatile semiconductor memory such as the flash memory card may be used. The medium reader 306, for example, stores the program or data read from the recording medium 14 in the RAM 302 or the HDD 303 according to the command from the processor 301.

The communication interface 307 is the communication interface for connecting with the management LAN 10. As the communication interface 307, for example, an Ethernet interface may be used.

The business server 400 and the terminal device 500 may also be implemented by the same hardware as the management server 300. In addition, the management server 300 is an example of the information processing apparatus 3 according to the first embodiment.

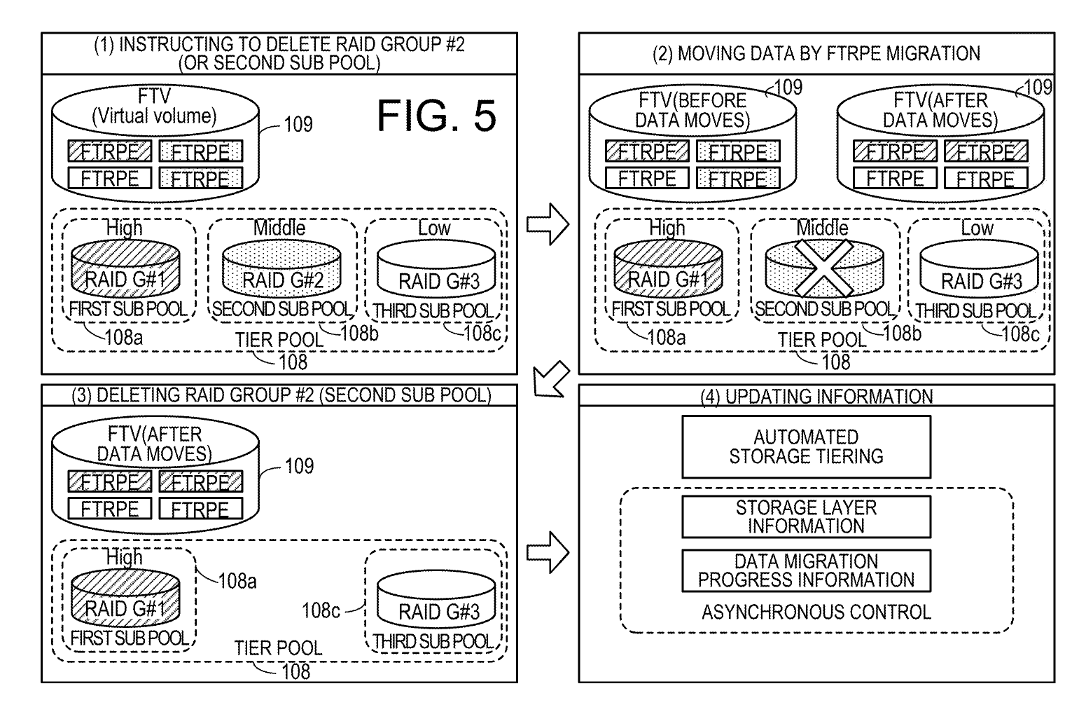

FIG. 5 is a diagram illustrating an example of a shrink function of the AST. The shrink function of the AST is a function of performing the removal of the RAID group or a sub pool by the storage device 100.

Herein, the one pool including SSD group 121, the online disk group 122, and the nearline disk group 123 mounted on DE 120 is called a tier pool. The virtual volume allocated to the tier pool is called a flexible tier volume (FTV). Further, each of the SSD group 121, the online disk group 122, and the near line disk group 123 is called the sub pool or a flexible tier sub pool (FTSP).

Specifically, the storage device 100 has a tier pool 108. The tier pool 108 which is an allocation source as a physical area for a virtual volume 109 provided by the storage device 100 is implemented by the storage device mounted on the DE 120.

The tier pool 108 has a first sub pool 108a, a second sub pool 108b, and a third sub pool 108c. The first sub pool 108a corresponds to the SSD group 121. The second sub pool 108b corresponds to the online disk group 122. The third sub pool 108c corresponds to the nearline disk group 123. In this way, the tier pool 108 is classified into three memory areas according to the access performance. The first sub pool 108a is a high-speed layer. The second sub pool 108b is a middle-speed layer. The third sub pool 108c is a low-speed layer.

One sub pool corresponds to one or more RAID groups configured by the memory devices having the same access performance.

In the storage device 100, the virtual volume 109 is configured as one of the virtual volumes that allow access by the business server 400. The virtual volume 109 is formed by a plurality of blocks. The corresponding block is called flexible tier pool element (FTRPE). The FTRPE is a relocation unit area in the AST and is allocated to any one physical area in the tier pool 108.

Specifically, each FTRPE of the virtual volume 109 is allocated to any one of the first sub pool 108a, the second sub pool 108b, and the third sub pool 108c. In the AST, the management server 300 controls the FTRPE of the virtual volume 109 to be allocated to the sub pool corresponding to the memory device having the higher access performance as the access frequency from the business server 400 to the corresponding FTRPE is higher. Meanwhile, when the access frequency of a predetermined FTRPE decreases, the management server 300 changes an allocation destination of the FTRPE to the sub pool corresponding to the memory device having lower access performance than the current memory device. In this case, according to the instruction from the management server 300, the storage device 100 relocates the data stored in the FTRPE from the memory device corresponding to the sub pool before the allocation is changed to the memory device corresponding to the sub pool after the allocation is changed.

More specifically, the storage device 100 allocates the FTRPE of the virtual volume 109 to an appropriate sub pool according to the access frequency from the business server 400 to the FTRPE. For example, the management server 300 acquires from the storage devices 100 and 200 information on the access frequency of the business server 400 with respect to the data of each FTRPE of the virtual volume 109. The management server 300 determines the appropriate sub pool to which each FTRPE is to be allocated based on the acquired access frequency information. When there is an FTRPE requiring the change of the allocation destination, the management server 300 notifies the sub pool of a new allocation destination of the FTRPE to the storage devices 100 and 200 to instruct the data of the FTRPE to be relocated in the sub pool of the new allocation destination.

By the AST, the data with the higher access frequency from the business server 400 has a higher response speed to an access request from the business server 400. As a result, response performance to the access request from the business server 400 is enhanced as a whole. Although the AST in the storage device 100 has been described, the storage device 200 likewise performs the AST according to the instruction of the management server 300.

The storage device 100 may remove a predetermined layer (sub pool) by the shrink function. In FIG. 5, the first sub pool 108a and the FTRPE allocated to the first sub pool 108a are illustrated by diagonal hatching. The second sub pool 108b and the FTRPE allocated to the second sub pool 108b are illustrated by hatching of dots. The third sub pool 108c and the FTRPE allocated to the third sub pool 108c are illustrated in white on a dark background. The first sub pool 108a is configured by RAID group #1 and the layer is “high.” The second sub pool 108b is configured by RAID group #2 and the layer is “middle.” The third sub pool 108c is configured by RAID group #3 and the layer is “low.”

In this case, the shrink function in the case where the storage device 100 receives a deletion instruction (removal instruction) of the RAID group #2 or the second sub pool 108b is exemplified.

(1) The storage device 100 receives the instruction to remove the RAID group #2 (or the second sub pool 108b) from the management server 300.

(2) The storage device 100 moves the FTRPE of the RAID group #2 (the second sub pool 108b) to be removed to another sub pool (FTRPE migration). In this case, the storage device 100 selects the sub pool of a migration destination based on a predetermined criterion.

(3) The storage device 100 removes the RAID group #2 (the second sub pool 108b) after moving the data.

(4) As the storage device 100 deletes the RAID group #2 (the second sub pool 108b), the storage device 100 updates layer information in the storage device 100. In addition, the storage device 100 responds with a state of the data migration when receiving a request for progress information of the data migration from the management server 300. The state of the data migration is information indicating, for example, the percent of data stored in a specific FTRPE that has moved to the migration destination.

By using such a shrink function, the capacity of the tier pool may be removed, and a removed portion may be used as a separate purpose. Alternatively, for example, it is possible to change a used disk by exchanging the online disk constituting the RAID group #2.

However, depending on a selection criterion of the relocation destination used by the storage device 100 in the above (2) of the shrink function, for example, when the RAID group #2 is deleted, the data blocks with the low access frequency may be relocated in the SSD. Further, on the contrary, the data blocks with the high access frequency are may be relocated in the nearline disk. Such inappropriate relocation is the cause for lowering the access performance to the data block with the high access frequency. Further, inappropriate relocation becomes the cause for the extra use of the memory area of the memory device having the high access performance by the data block having the low access frequency.

Therefore, the storage device 100 provides a function of suppressing such inappropriate relocation in the shrink function.

Next, the processing of the information processing system will be described in detail. Further, in the following description, an address in the virtual volume is referred to as a “logical address” and the address in the sub pool is referred to as a “physical address.”

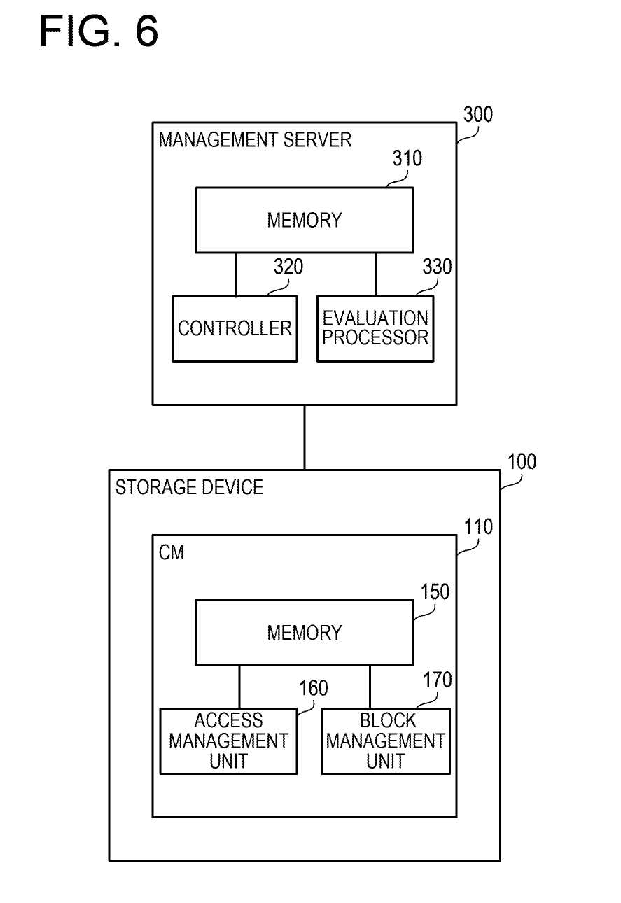

FIG. 6 is a diagram illustrating a functional example of the information processing system. The CM 110 includes a memory 150, an access management unit 160, and a block management unit 170. The memory 150 is implemented by, for example, the memory area of the RAM 112 or the flash memory 113. The access management unit 160 and the block management unit 170 are implemented by the processor 111. For example, the processor 111 exerts the functions of the access management unit 160 and the block management unit 170 by executing the program stored in the RAM 112. The access management unit 160 and the block management unit 170 may be implemented by hard wired logic such as the FPGA or ASIC.

The memory 150 stores a bit string (FTRPE individual information) and a volume management table. In the bit string (FTRPE individual information), ranking information according to the evaluation of the access frequency for each FTRPE and information indicating the layers of a latest migration source and a latest migration destination by the AST is registered. The ranking is the ranking of the access frequency among all FTRPEs in the tier pool. The volume management table is information indicating the correspondence relationship between each FTRPE of the virtual volume and the physical area of the sub pool of the allocation destination.

The access management unit 160 receives the access request from the business server 400. The access request is, for example, a request for writing the data or a request for reading the data. The access management unit 160 refers to the volume management table stored in the memory 150 to execute processing according to the access request. The access management unit 160 responds to the business server 400 with a processing result (a data writing result or read data) according to the access request.

The access management unit 160 acquires a reception frequency (access frequency) of the access request by the business server 400 for each FTRPE and provides the acquired reception frequency to the management server 300. The access frequency of the FTRPE is the number of access requests for the corresponding FTRPE accepted per unit time. The access frequency may also be referred to as TOPS.

According to the instruction from the management server 300, the block management unit 170 changes the correspondence relationship between the FTRPE and the physical area in the volume management table to relocate the FTRPE from a predetermined layer to a separate layer (AST). The FTRPE to be relocated and the relocation destination are instructed from the management server 300.

Even in the case of executing the shrink function, the block management unit 170 changes the correspondence relationship between the FTRPE and the physical area in the volume management table (accompanying the actual movement of the FTRPE) to relocate the FTRPE from a predetermined layer to a separate layer. When executing the shrink function, the block management unit 170 determines the relocation destination of the FTRPE according to the ranking information according to the evaluation of the access frequency for each FTRPE. The block management unit 170 acquires the ranking information from the management server 300, stores the acquired ranking information in each FTRPE (a part of the memory area corresponding to the FTRPE), and uses the stored ranking information at the time of executing the shrink function. The block management unit 170 generates the bit string including the aforementioned ranking information and stores the generated bit string in each FTRPE. When the shrink function is executed, the block management unit 170 determines the FTRPE relocation destination by itself.

The storage device 200 also has the same function as the storage device 100.

The management server 300 includes a memory 310, an AST control unit 320, and an evaluation processor 330. The memory 310 is implemented by, for example, the memory area of a RAM 302 or an HDD 303. The AST control unit 320 and the evaluation processor 330 are implemented by a processor 301. For example, the processor 301 exerts the functions of the AST control unit 320 and the evaluation processor 330 by executing the program stored in the RAM 302. The AST control unit 320 and the evaluation processor 330 may be implemented by the hard-wired logic such as the FPGA or ASIC.

The memory 310 stores an allocation management table, an access frequency table, and an evaluation information management table. The allocation management table is information for managing the FTRPE and the sub pool allocated to FTRPE. The allocation management table is created for each virtual volume. The allocation management table includes information on the correspondence relationship between the sub pool of the virtual volume and each FTRPE. The access frequency management table is information indicating the access frequency for each FTRPE. The evaluation information management table is information indicating the result of evaluating and prioritizing the access frequency for each FTRPE.

The AST control unit 320 controls the relocation of the FTRPE by the storage devices 100 and 200. The AST control unit 320 instructs the storage devices 100 and 200 to relocate the FTRPE between the layers based on the ranking (the evaluation information management table stored in the memory 310) according to a height of the access frequency of each FTRPE. The AST control unit 320 relocates the FTRPE with the high access frequency in the layer of the memory device with the high access performance and relocates the FTRPE with the low access frequency in the layer of the memory device with the low access performance. An execution cycle of the AST is determined according to the operation such as, for example, daily, or weekly.

Upon receiving an AST progress confirmation request command from the terminal device 500, the AST control unit 320 makes an inquiry about the progress of the AST to the storage devices 100 and 200. The AST control unit 320 receives the progress information indicating the progress of the AST from the storage devices 100 and 200 and responds to the terminal device 500 with the progress information.

The evaluation processor 330 acquires the information on the access frequency for each FTRPE from the storage devices 100 and 200 and registers the acquired information in the access frequency table stored in the memory 310. A cycle of collecting the information on the access frequency is arbitrarily determined according to the operation (e.g., a cycle of 5 minutes). The evaluation processor 330 evaluates the access frequency of each FTRPE based on the access frequency table. An evaluation period is arbitrarily determined according to the operation such as the past 24 hours or the past week. Specifically, the evaluation processor 330 determines the ranking of each FTRPE according to the height of the access frequency (for example, an average or a maximum value in the evaluation period) and registers the ranking in the evaluation information management table stored in the memory 310. The higher the access frequency, the smaller a ranking value. Further, the lower the access frequency, the higher the ranking value. In addition, the evaluation processor 330 provides the ranking information to the storage devices 100 and 200.

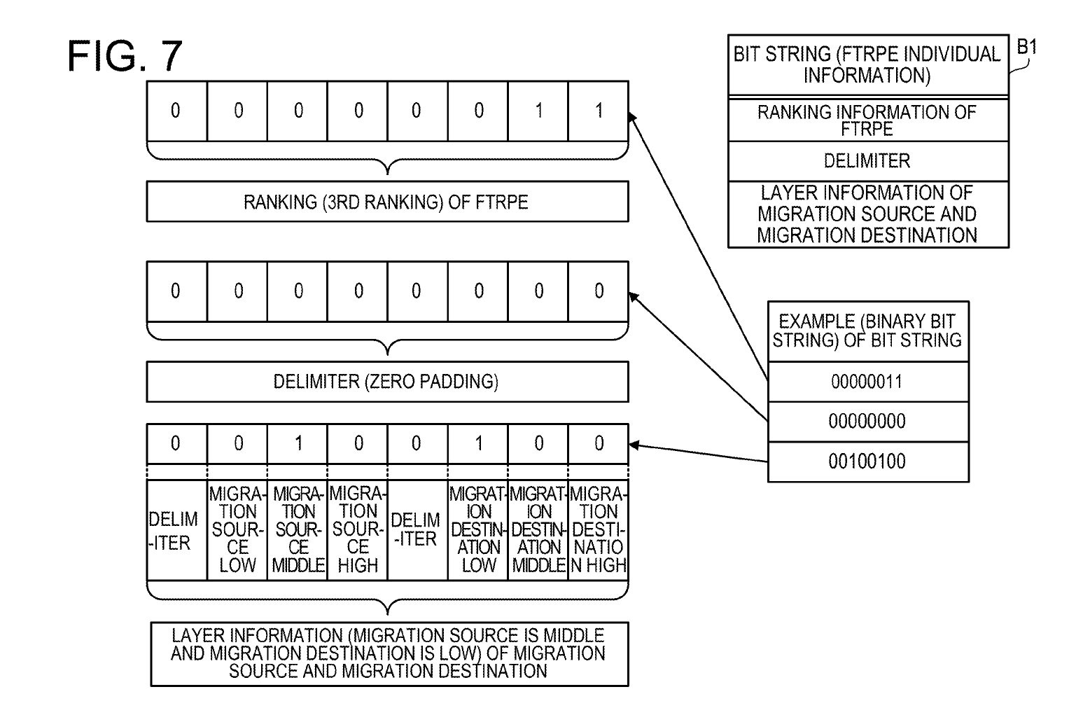

FIG. 7 is a diagram illustrating an example of a bit string (FTRPE individual information). A bit string B1 is generated for each FTRPE by the block management unit 170. The bit string B1 is stored in a part of the physical area corresponding to the FTRPE and loaded to the RAM 112 according to the processing of the CM 110. The bit string B1 includes fields of the ranking information of the FTRPE, a delimiter, and layer information of the migration source and the migration destination. In the example of the bit string B1, a bit length of each field is 8.

In the field of the ranking information of the FTRPE, the ranking of the access frequency of the corresponding FTRPE acquired from the management server 300 is registered. “0” for 8 bits is registered in the delimited field. In the field of the layer information of the migration source and the migration destination, information indicating the layer of the migration source and information indicating the layer of the migration destination accompanied by latest execution of the AST or shrink function are registered.

Specifically, first four bits of 8 bits of the field of the layer information of the migration source and the migration destination indicate the layer of the migration source. Further, last 4 bits of the same 8 bits indicate the layer of the migration destination. A first bit of first 4 bits and the first bit (the first bit from the top) of last 4 bits is a delimiter bit, which is fixed to “0.” The second most significant bit of first 4 bits and the second most significant bit of last 4 bits indicate the “low” layer. Further, as the bit, “1” is TRUE (applicable) and “0” indicates FALSE (not applicable) (the same applies to other bits except for the delimiter bit of the same field). The third most significant bit of first 4 bits and the third most significant bit of last 4 bits indicate the “middle” layer. The fourth most significant bit of first 4 bits and the fourth most significant bit of last 4 bits indicate the “high” layer.

For example, the bit string B1 is “000000110000000000100100.” This indicates that the corresponding FTRPE ranking is “3,” the latest migration source layer by the AST or shrink function is “Middle,” and the migration destination layer is “Low.” Further, the field of the ranking information of the FTRPE may be extended according to the number of FTRPEs. For example, when more FTRPEs are managed, 8 bits or more may be further added to the field of the ranking information of the FTRPE.

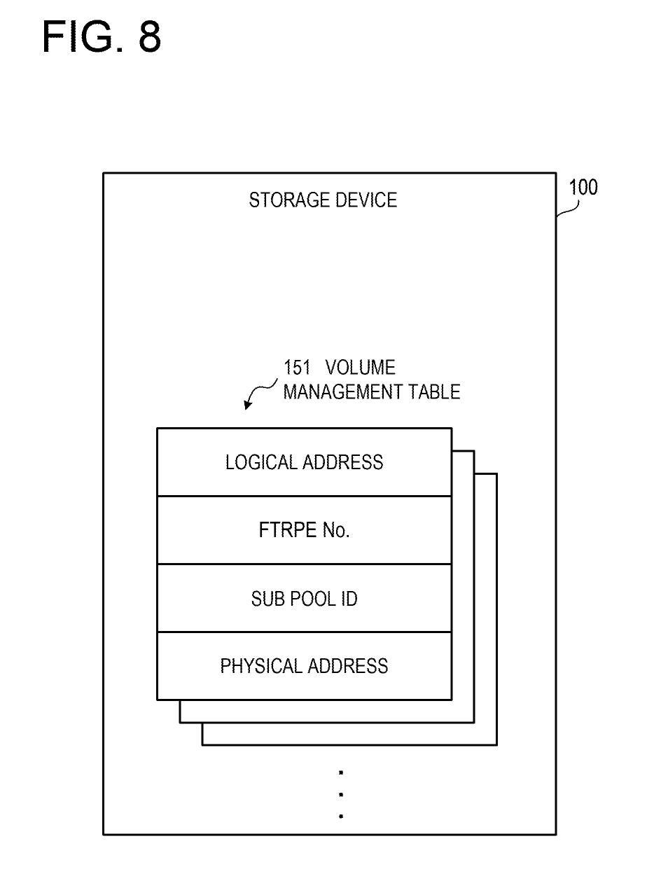

FIG. 8 is a diagram illustrating an example of a volume management table. The volume management table 151 is stored in the memory 150. The volume management table 151 has a record for each FTRPE of the virtual volume 109 in the storage device 100. Each record includes items of the logical address, FTRPE No., the sub pool ID, and the physical address. In the item of the logical address, a head logical address of a divided area in the virtual volume 109 is registered.

In the item of the logical address, the logical address in the virtual volume to which the FTRPE is allocated is registered. In the item of the FTRPE No., identification information of the FTRPE is registered. In the item of the sub pool ID, the identification information of the sub pool allocated to the FTRPE is registered. In the item of the physical address, the physical address in the sub pool allocated to the FTRPE is registered.

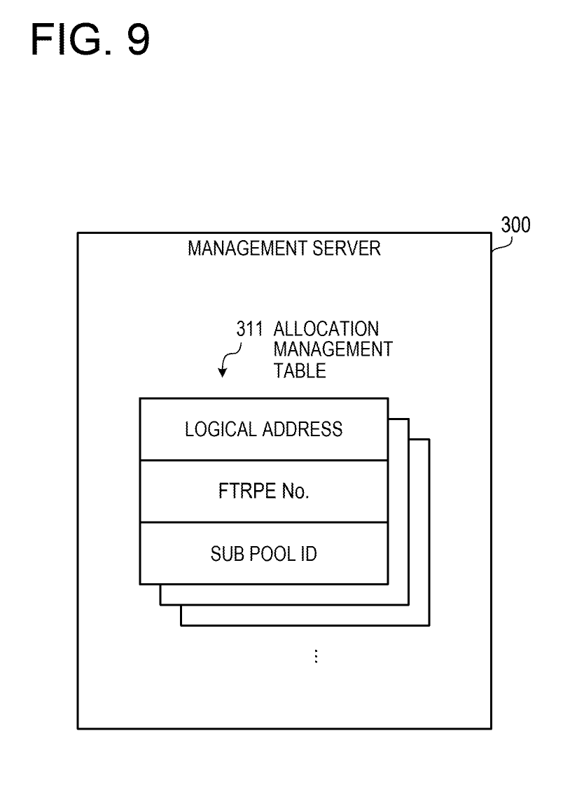

FIG. 9 is a diagram illustrating an example of an allocation management table. The allocation management table 311 is stored in the memory 310. The allocation management table 311 is information for managing the FTRPE and the sub pool allocated to FTRPE. The allocation management table 311 is created for each virtual volume. Each record includes the items of the logical address, the FTRPE No., and the sub pool ID. In the item of the logical address, the head logical address of the FTRPE in the virtual volume 109 is registered. In the item of the FTRPE No., the identification information of the FTRPE is registered. In the item of the sub pool ID, the identification information of the sub pool allocated to the FTRPE is registered.

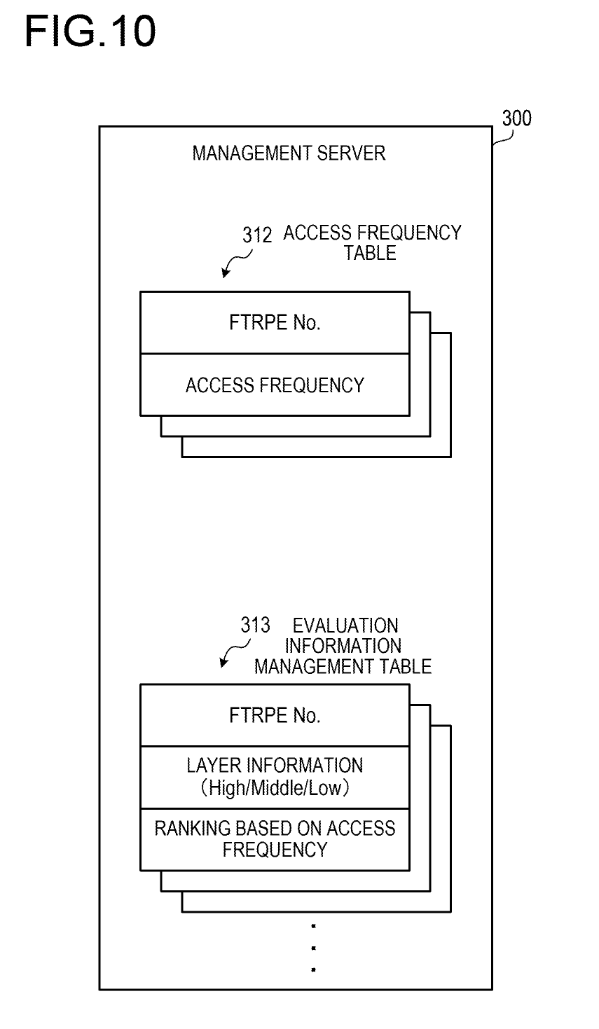

FIG. 10 is a diagram illustrating examples of an access frequency table and an evaluation information management table. The access frequency table 312 and the evaluation information management table 313 are stored in the memory 310.

The access frequency table 312 has the record for each FTRPE of the virtual volume 109. Each record includes the items of the FTRPE No. and the access frequency. In the item of the FTRPE No., the identification information of the FTRPE is registered. In the item of access frequency, a value of the access frequency measured for the data stored in the FTRPE is registered. As described above, the access frequency may be TOPS (the number of accesses per unit time). The access frequency of the FTRPE is measured at regular intervals by each storage device and transmitted to the management server 300. Each time the management server 300 receives the access frequency for each FTRPE from each storage device, the management server 300 may update a registration value of the item of the access frequency for each FTRPE according to a latest measurement value. Alternatively, the management server 300 may accumulate the access frequency for a predetermined period for each FTRPE and may obtain, for example, the average, or the maximum value of the access frequency in the predetermined period, and register the acquired average or maximum value in the access frequency table 312.

The evaluation information management table 313 has the record for each FTRPE of the virtual volume 109. Each record includes the item of the ranking based on the FTRPE No., the layer information (high/middle/low), and the access frequency.

In the item of the FTRPE No., the identification information of the FTRPE is registered. In the item of the layer information, information indicating any one of the “high,” “middle,” and “low” layers to which the FTRPE belongs is registered. In the item of the ranking based on the access frequency, the ranking information according to the access frequency of each FTRPE is registered. The ranking according to the access frequency is a result obtained by giving the ranking in a descending order of the access frequency value of each FTRPE based on the access frequency table 312 by the management server 300.

Next, data relocation processing will be described with reference to a flowchart. First, the order of the relocation accompanied by the shrink function (function of layer configuration change) performed by the storage device 100 and the management server 300 will be described.

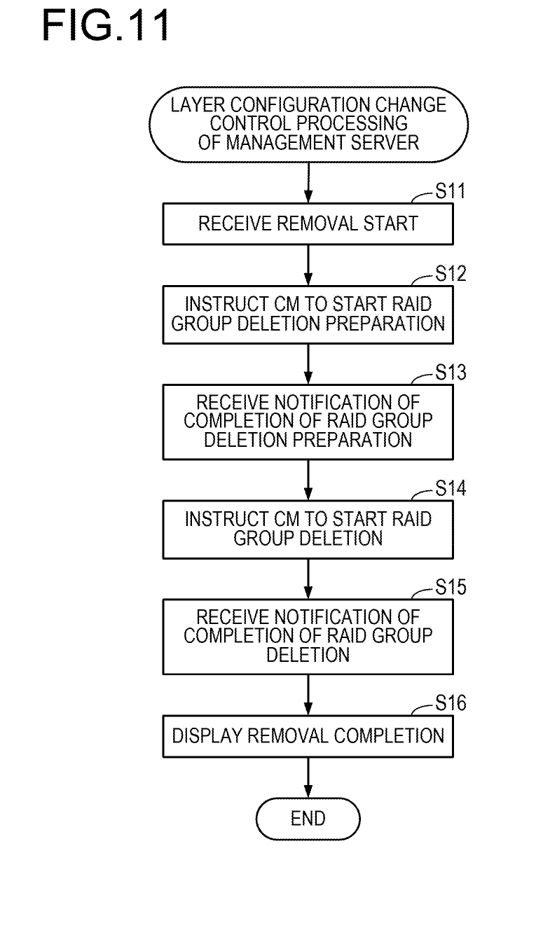

FIG. 11 is a flowchart illustrating an example of layer configuration change control processing of a management server. Hereinafter, the processing illustrated in FIG. 11 will be described along a step number.

(S11) The AST control unit 320 of the management server 300 receives a request for starting the removal (shrink control start) from the terminal device 500. The request to start the reduction includes information designating the RAID group or sub pool to be reduced.

(S12) The AST control unit 320 instructs the CM 110 to start RAID group deletion preparation. Further, when a plurality of storage devices is present in the information processing system, the AST control unit 320 identifies the CM based on the information designating the RAID group or sub pool received in step S11 and instructs the start of the deletion preparation.

(S13) The AST control unit 320 receives from the CM 110 a notification of completion of the RAID group deletion preparation.

(S14) The AST control unit 320 instructs the CM 110 to start the RAID group deletion.

(S15) The AST control unit 320 receives from the CM 110 the notification of completion of the RAID group deletion.

(S16) The AST control unit 320 transmits a message of the removal completion to the terminal device 500 and display the message of the removal completion in a display of the terminal device 500. In addition, the AST control unit 320 ends the layer configuration change control processing.

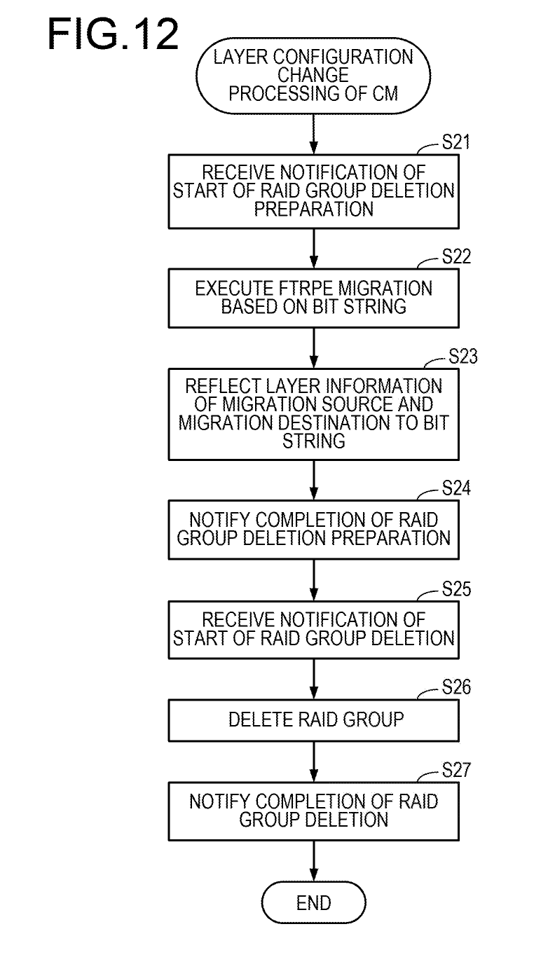

FIG. 12 is a flowchart illustrating an example of layer configuration change processing of a CM. Hereinafter, the processing illustrated in FIG. 12 will be described along the step number.

(S21) The block management unit 170 receives the notification of the RAID group deletion preparation start from the management server 300. Further, the RAID group deletion preparation start notification includes information identifying the RAID group to be deleted.

(S22) The block management unit 170 executes FTRPE migration based on the bit string B1 for each FTRPE. That is, the block management unit 170 executes the processing of moving the FTRPE based on the FTRPE ranking information included in the bit string B1 corresponding to the FTRPE for the FTRPE included in the RAID group to be deleted. The block management unit 170 relocates the FTRPE with the small ranking value to the layer with the high access performance and relocates the FTRPE with the high ranking value to the layer with the low access performance.

(S23) The block management unit 170 reflects the layer information of the migration source and the migration destination in the FTRPE after execution of the FTRPE migration to the bit string B1 of each relocated FTRPE.

(S24) The block management unit 170 notifies the management server 300 of the completion of the RAID group deletion preparation.

(S25) The block management unit 170 receives the notification of the RAID group deletion start from the management server 300.

(S26) The block management unit 170 deletes the RAID group to be deleted.

(S27) The block management unit 170 notifies the completion of the RAID group deletion to the management server 300 and ends the layer configuration change processing.

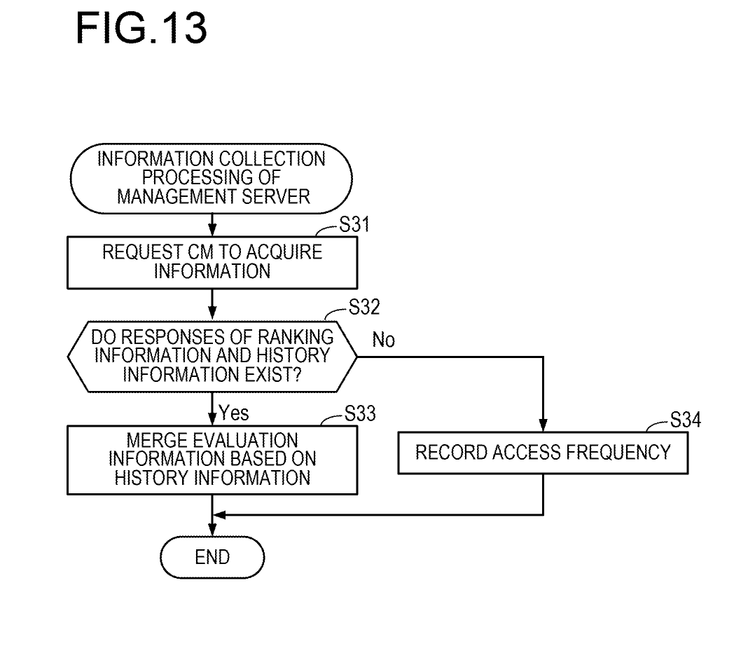

FIG. 13 is a flowchart illustrating an example of information collection processing of the management server. Hereinafter, the processing illustrated in FIG. 13 will be described along the step number. The information collection processing is processing executed by the management server 300 at a predetermined interval (e.g., every 5 minutes).

(S31) The evaluation processor 330 requests the CM 110 to acquire information.

(S32) The evaluation processor 330 determines whether there are responses of the ranking information and history information. When it is determined that there is a response, the evaluation processor 330 proceeds to step S33, and when it is determined that there is no response, the evaluation processor 330 proceeds to step S34. Further, the ranking information is the ranking of the access frequency of the FTRPE included in the bit string B1. In addition, the history information is the layer information of the migration source and the migration destination of the FTRPE included in the bit string B1.

(S33) The evaluation processor 330 merges the evaluation information based on the history information and the ranking information received from the CM 110 and ends the information collection processing. In merging the evaluation information, the evaluation processor 330 updates an affiliation layer of the FTRPE relocated by the shrink function in the evaluation information management table 313 based on the history information (including the FTRPE No. corresponding to the history information) received from the CM 110. That is, the evaluation processor 330 searches the record including the FTRPE No. and the layer of the migration source from the evaluation information management table 313, and updates the layer information of the corresponding record to the layer of the migration destination.

(S34) The evaluation processor 330 writes the access frequency received from the CM 110 to the access frequency table 312 and ends the information collection processing.

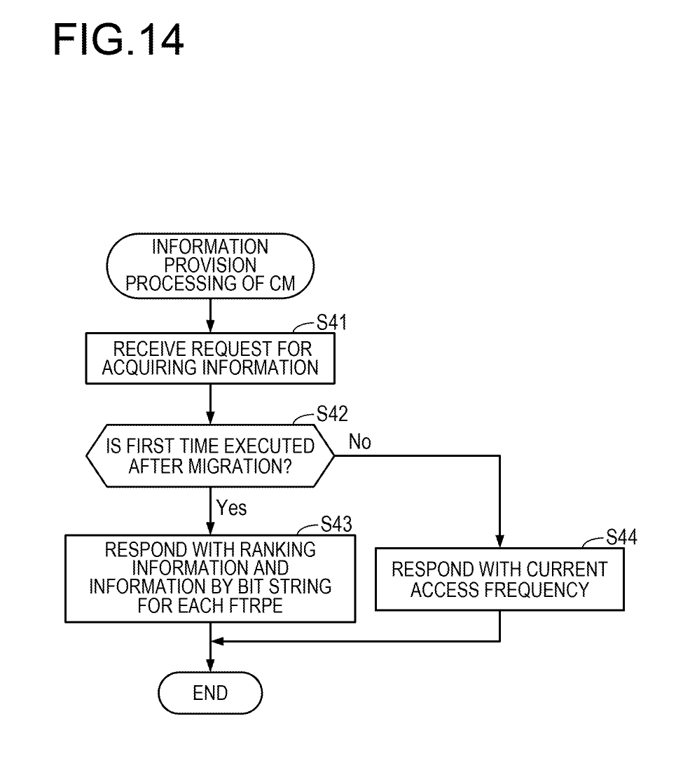

FIG. 14 is a flowchart illustrating an example of information providing processing of the CM. Hereinafter, the processing illustrated in FIG. 14 will be described along the step number.

(S41) The access management unit 160 receives an information acquisition request from the management server 300.

(S42) The access management unit 160 determines whether information provision after the FTRPE migration by the shrink function is first executed. In the case of the first execution, the access management unit 160 proceeds to step S43 and when this time is not the first execution, the access management unit 160 proceeds to step S44.

(S43) The access management unit 160 responds to the management server 300 with the ranking information and the layer information included in the bit string B1 for each FTRPE and ends the information provision processing.

(S44) The access management unit 160 responds to the management server 300 with the current access frequency for each FTRPE and ends the information provision processing.

Herein, with respect to each FTRPE, the history information (the layer of the migration source/migration destination) of the AST is held by the bit string B1. In addition, as in step S33 of FIG. 13, the evaluation processor 330 acquires the history information (including the FTRPE No. corresponding to the history information) from the storage device 100 to update an affiliation destination (layer information) of the FTRPE in the evaluation information management table 313.

Specifically, the evaluation processor 330 searches the record including the FTRPE No. and the layer of the migration source from the evaluation information management table 313 and updates the layer information of the corresponding record to the layer of the migration destination. In this way, the evaluation processor 330 may appropriately reflect the layer of each FTRPE after the shrink function is executed to the evaluation information management table 313. In other words, the management server 300 appropriately takes over the evaluation information before the shrink function is executed even after the shrink function is executed.

Meanwhile, when the history information is not used, the AST is temporarily stopped when the shrink function is executed. The reason is that the layer of the migration source/migration destination and the evaluation result of the access frequency may not be correlated, collection of the access situation such as, for example, the access frequency and the evaluation processing are performed again.

Therefore, the storage device 100 manages the history information by the bit string B1 and transmits the managed history information to the management server 300, thereby appropriately updating the evaluation information management table 313 of the management server 300. Therefore, the management server 300 may not create the evaluation information management table 313 again by temporarily stopping the AST. Therefore, the shrink function may be executed without stopping the AST. That is, even when the shrink function is executed, the operation by the AST may be continued without stopping the AST.

Next, the order of the AST by the storage device 100 and the management server 300 will be described.

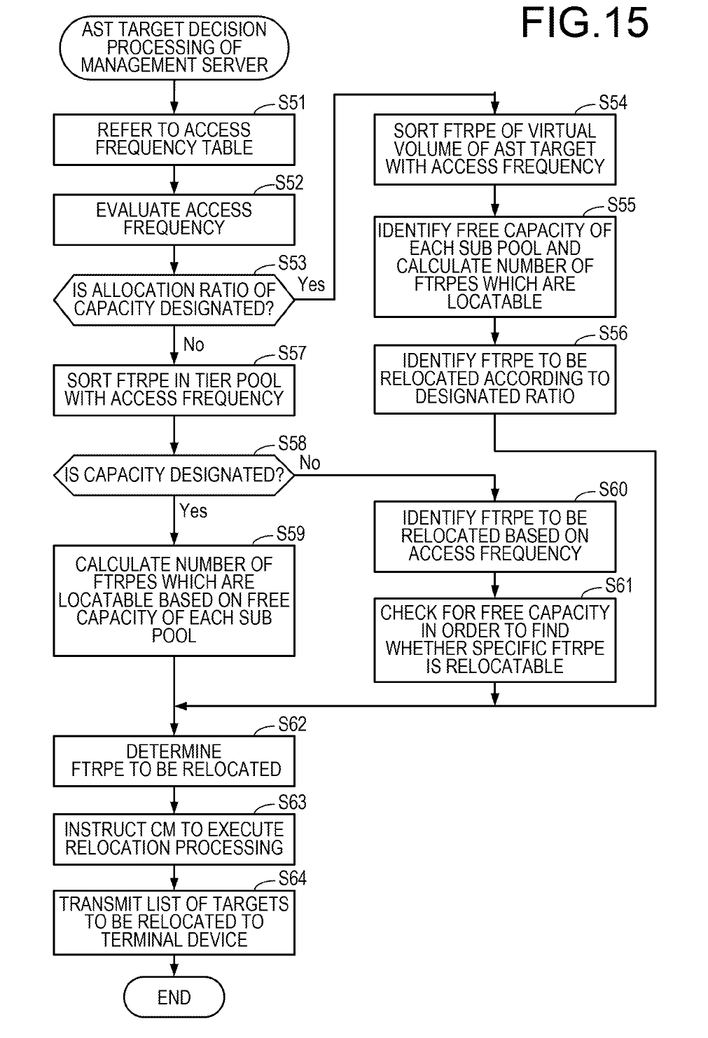

FIG. 15 is a flowchart illustrating an example of AST object decision processing of the management server. Hereinafter, the processing illustrated in FIG. 15 will be described along the step number.

(S51) The evaluation processor 330 refers to the access frequency table 312.

(S52) The evaluation processor 330 evaluates the access frequency according to the policy. The evaluation processor 330 may acquire the average access frequency in a predetermined evaluation period or may acquire the maximum access frequency. In addition, for example, the evaluation processor 330 evaluates the access frequency in the descending order of the access frequency of each FTRPE, gives the ranking, and registers the access frequency in the evaluation information management table 313.

(S53) The AST control unit 320 determines whether a capacity allocation ratio for each sub pool is designated as the policy. When it is determined that the capacity allocation ratio for each sub pool is designated, the AST control unit 320 proceeds to step S54, and when it is determined that the capacity allocation ratio is not designated, the AST control unit 320 proceeds to step S57.

(S54) The AST control unit 320 refers to the evaluation information management table 313 and sorts each FTRPE of the AST target virtual volume according to the ranking of the access frequency.

(S55) The AST control unit 320 identifies a free capacity of each sub pool and calculates the number of FTRPEs that may be located in each sub pool.

(S56) In accordance with the designated ratio, the AST control unit 320 identifies the FTRPE to be relocated from a sorting result of step S54 and proceeds to step S62.

(S57) The AST control unit 320 refers to the evaluation information management table 313 and sorts the FTRPE in the tier pool 108 according to the ranking of the access frequency.

(S58) The AST control unit 320 determines whether the capacity is designated for each sub pool. When it is determined that the capacity is designated, the AST control unit 320 proceeds to step S59, and when it is determined that the capacity is not designated, the AST control unit 320 proceeds to step S60.

(S59) The AST control unit 320 calculates the number of FTRPEs that may be relocated based on the free capacity of each sub pool and proceeds to step S62.

(S60) The AST control unit 320 identifies the FTRPE to be relocated from the sorting result of step S57 based on the access frequency.

(S61) The AST control unit 320 checks for the free capacity of each sub pool in order to determine whether the FTRPE identified in step S60 may be relocated.

(S62) The AST control unit 320 determines the FTRPE to be relocated and the layer of the relocation destination from the results of the processing of steps S54 to S56, step S59 or steps S60 and S61.

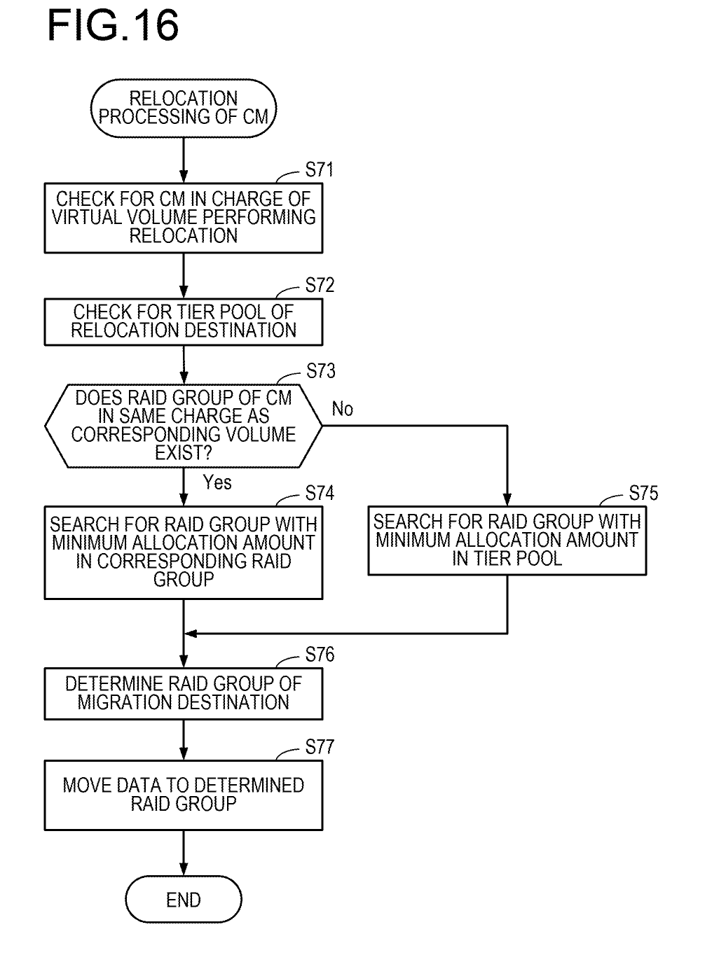

(S63) The AST control unit 320 designates the FTRPE to be relocated and the layer of the relocation destination and instructs the CM 110 to execute the relocation processing. The relocation processing by the CM 110 will be described below with reference to FIG. 16.

(S64) The AST control unit 320 transmits a list of targets to be relocated to the terminal device 500 and ends the AST target decision processing. By displaying the list of relocation targets by the terminal device 500, a system administrator may visually check for the relocation target.

FIG. 16 is a flowchart illustrating an example of relocation processing of the CM. Hereinafter, the processing illustrated in FIG. 16 will be described along the step number.

(S71) The block management unit 170 checks for the CM 110 in charge of the virtual volume to be relocated. For example, when there is a plurality of CMs in the storage device 100, the CM that is in charge of an access to the virtual volume to be relocated is identified.

(S72) The block management unit 170 checks for the tier pool of the relocation destination.

(S73) The block management unit 170 belongs to the layer of the relocation destination and determines whether there is the RAID group of the CM 110 which is in the same charge as the virtual volume to be relocated. When there is the corresponding RAID group, the block management unit 170 proceeds to step S74 and when there is no corresponding RAID group, the block management unit 170 proceeds to step S75.

(S74) The block management unit 170 searches for the RAID group with the minimum allocation amount among the corresponding RAID groups identified in step S73 and proceeds to step S76.

(S75) The block management unit 170 belongs to the layer of the relocation destination, searches for the RAID group with the minimum allocation amount in the tier pool, and proceeds to step S76.

(S76) The block management unit 170 determines the RAID group of the migration destination.

(S77) The block management unit 170 moves the data to the RAID group of the migration destination determined in step S76 and ends the processing.

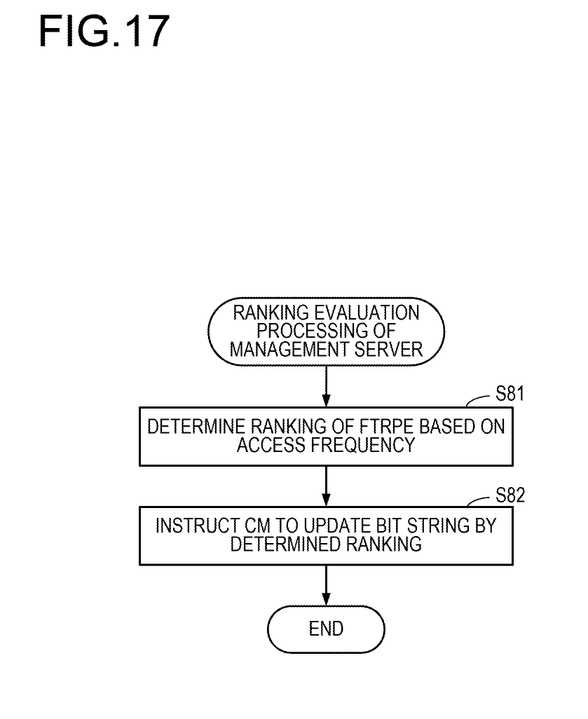

FIG. 17 is a flowchart illustrating an example of ranking evaluation processing of the management server. Hereinafter, the processing illustrated in FIG. 17 will be described along the step number.

(S81) The evaluation processor 330 determines the ranking of the FTRPE based on the access frequency for each FTRPE registered in the access frequency table 312. The evaluation processor 330 updates the evaluation information management table 313 based on the access frequency table 312.

(S82) The evaluation processor 330 instructs the CM 110 to update the bit string B1 according to the determined ranking and ends the processing.

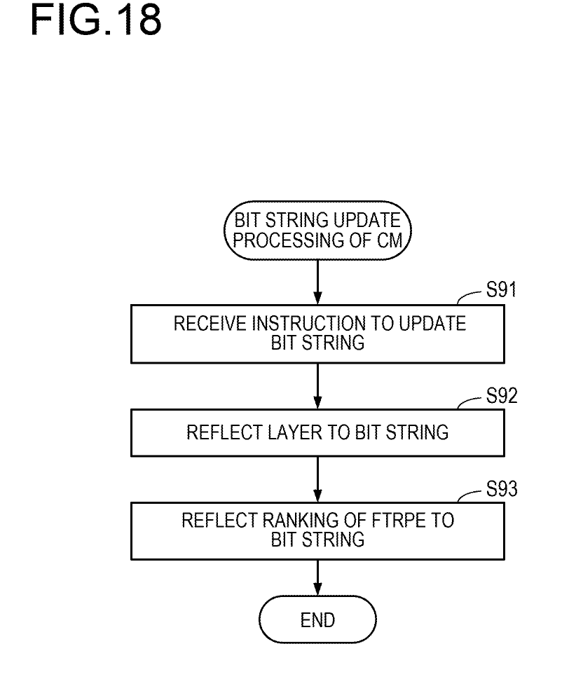

FIG. 18 is a flowchart illustrating an example of bit string update processing of the CM. Hereinafter, the processing illustrated in FIG. 18 will be described along the step number.

(S91) The block management unit 170 receives the instruction of updating the bit string B1 from the management server 300.

(S92) The block management unit 170 reflects the current layer of the FTRPE to the bit string B1. The block management unit 170 sets each FTRPE to the bit string B1.

(S93) The block management unit 170 reflects the ranking of the FTRPE received from the management server 300 to the bit string B1 of the FTRPE, and ends the processing. The block management unit 170 sets each FTRPE to the bit string B1.

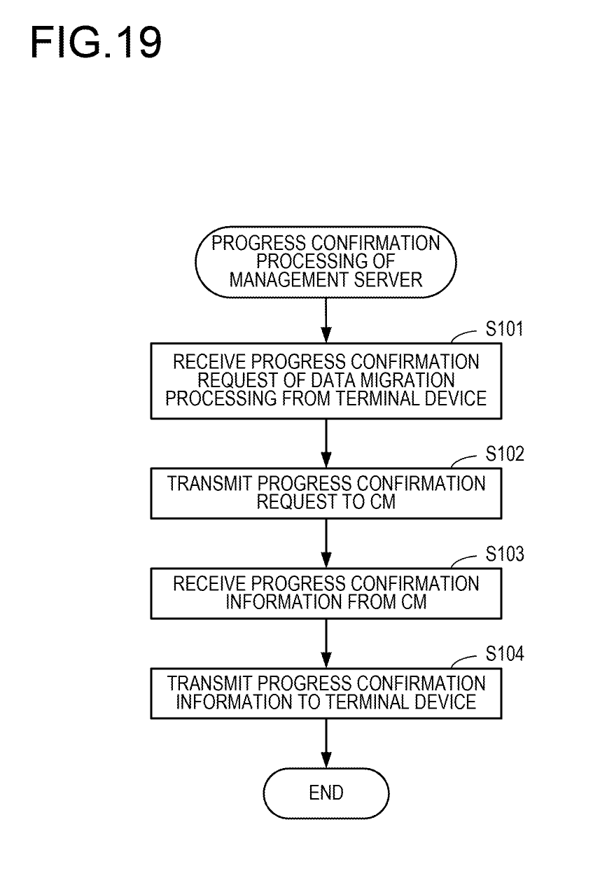

FIG. 19 is a flowchart illustrating an example of progress confirmation processing of the management server. Hereinafter, the processing illustrated in FIG. 19 will be described along the step number.

(S101) The AST control unit 320 receives a progress confirmation request of the data migration processing from the terminal device 500.

(S102) The AST control unit 320 transmits the progress confirmation request to the CM 110.

(S103) The AST control unit 320 receives progress confirmation information from the CM 110. The progress confirmation information includes data of migration completion or information on the ratio of FTRPE or information identifying the migration target and the FTRPE of the migration completion.

(S104) The AST control unit 320 transmits the progress confirmation information received in step S103 to the terminal device 500 and ends the processing. The terminal device 500 presents the contents of the progress confirmation information to the system administrator by displaying the contents of the progress confirmation information received from the management server 300 on the display of the terminal device 500.

Next, the relocation of the FTRPE will be described.

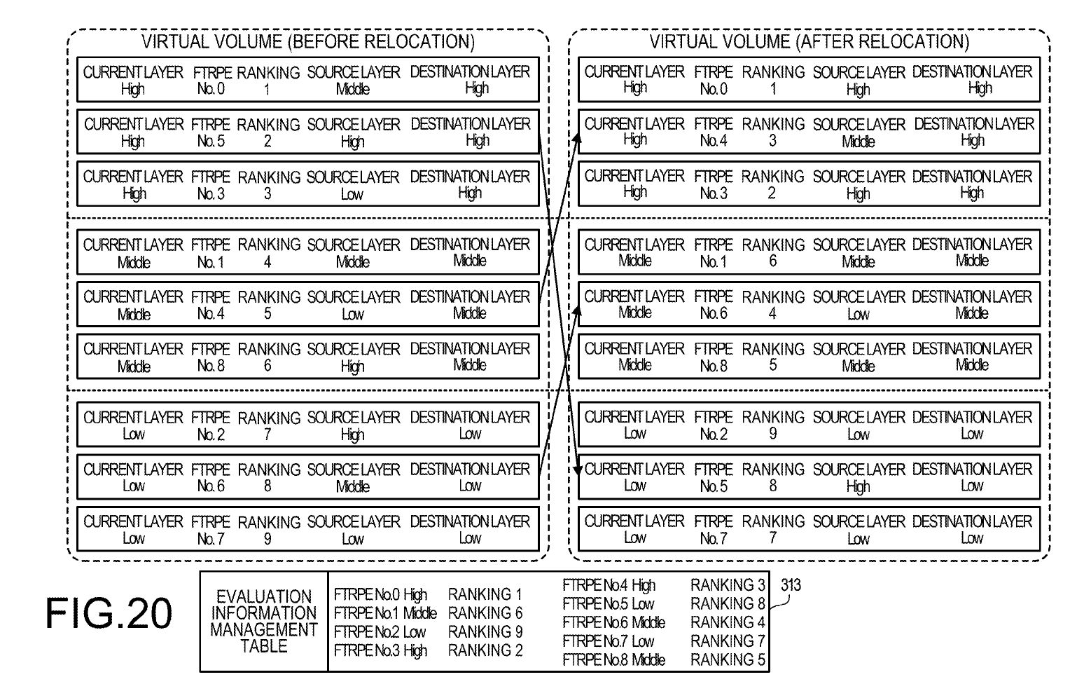

FIG. 20 is a diagram illustrating a specific example of relocation processing by AST. Herein, the FTRPE of each of the first sub pool 108a, the second sub pool 108b, and the third sub pool 108c is allocated to the virtual volume 109. As described above, the layers of the first sub pool 108a, the second sub pool 108b, and the third sub pool 108c are “high,” “middle,” and “low,” respectively. Here, it is assumed that three FTRPEs are allocated in the sub pool of each of the “high,” “middle,” and “low” layers before and after relocation.

In FIG. 20, an example of the relocation of the FTRPE by normal AST will be described. Each FTRPE is relocated based on the evaluation result of the access frequency in order to enhance the access performance to the data. The CM 110 executes the relocation of the FTRPE based on the evaluation information acquired from the management server 300. The identification information (FTRPE No.) for identifying the FTRPE is allocated to each FTRPE.

In the virtual volume before the relocation, the layer “high” includes three FTRPEs “FTRPE No. 0,” “FTRPE No. 5,” and “FTRPE No. 3.” Further, the layer “middle” includes three FTRPEs “FTRPE No. 1,” “FTRPE No. 4,” and “FTRPE No. 8.” In addition, the layer “low” includes three FTRPEs “FTRPE No. 2,” “FTRPE No. 6,” and “FTRPE No. 7.”

The evaluation information is the information of the ranking according to the access frequency for each FTRPE indicated in the evaluation information management table 313 and is information received from the management server 300 by the CM 110.

Based on the evaluation information, the CM 110 selects the FTRPE to be moved from the current layer to another layer. The evaluation information includes the ranking given to each FTRPE according to the access frequency. Based on the ranking, the CM 110 selects the FTRPE to be relocated from the current layer to another layer. Specifically, the CM 110 locates FTRPEs having three highest rankings in the layer “high,” locates FTRPEs having 4th to 6th rankings in the layer “Middle,” and locates FTRPEs having 7th to 9th rankings in the layer “low.”

Since “FTRPE No. 5” is “ranking 8,” the CM 110 sets the layer of the migration destination as “low” and since “FTRPE No. 4” is “ranking 3,” the CM 110 sets the layer of the migration destination as “high.” Further, since “FTRPE No. 6” is “ranking 4,” the CM 110 sets the layer of the migration destination as “middle.”

The CM 110 moves the FTRPE to be relocated to the layer of the migration destination and allocates the FTRPE to the sub pool of each layer.

In this way, when a plurality of FTRPEs is included in the virtual volume, the CM 110 may perform storage tiering on the plurality of FTRPEs included in the virtual volume. Further, the CM 110 may enhance the access performance by performing the relocation based on the access frequency of each FTRPE.

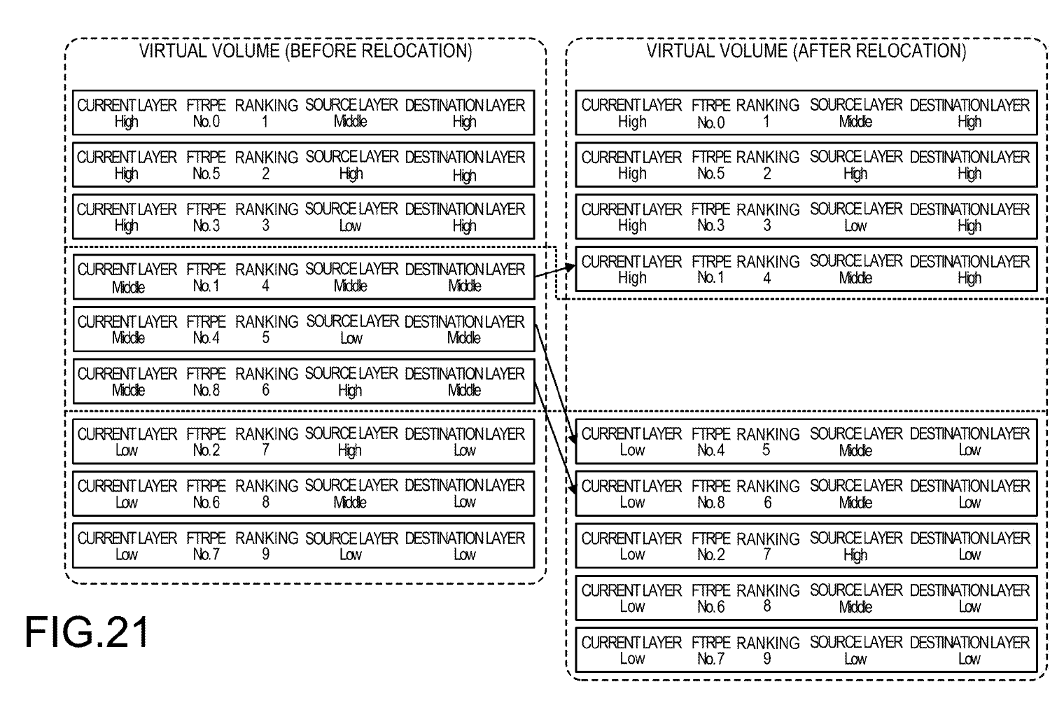

FIG. 21 is a diagram illustrating a specific example of relocation processing at the time of executing a shrink function. Similarly to FIG. 20, three sub pools of the first sub pool 108a, the second sub pool 108b, and the third sub pool 108c are included in the virtual volume 109. Further, the layers of the first sub pool 108a, the second sub pool 108b, and the third sub pool 108c are “high,” “middle,” and “low,” respectively.

Herein, it is assumed that three FTRPEs are held in the sub pool of each of the “high,” “middle,” and “low” layers before the relocation. Further, it is assumed that in the sub pool of each layer after the relocation, the FTRPE is located based on the performance. For example, it is assumed that the “high” layer after the relocation holds the FTRPEs having four highest rankings according to the evaluation based on the performance and the “low” layer after the relocation holds the FTRPEs having 5th to 9th rankings according to the evaluation based on the performance. Further, the number of FTRPEs held by the sub pool of each layer is just an example and the FTRPE may be allocated to each layer at other ratios.

In FIG. 21, an example of relocation of FTRPE in the case where the RAID group (or sub pool) is removed will be described. Herein, it is assumed that the RAID group (sub pool) corresponding to the layer “Middle” is removed. Further, description of parts similar to those in FIG. 20 will be appropriately omitted.

Based on the bit string B1 held for each FTRPE by the storage device 100, the CM 110 determines the layer of the migration destination of the FTRPE belonging to the layer “Middle” to be removed. Since “FTRPE No. 1” is “ranking 4,” the CM 110 sets the layer of the migration destination as “high” and since “FTRPE No. 4” is “ranking 5,” the CM 110 sets the layer of the migration destination as “low.” Further, since “FTRPE No. 8” is “ranking 6,” the CM 110 sets the layer of the migration destination as “low.”

The CM 110 moves the FTRPE to be relocated to the layer of the migration destination and allocates the FTRPE to the sub pool of each layer. Further, in FIG. 21, only for the FTRPE included in the RAID group (“middle” layer) to be removed is relocated and the migration source layer and the migration destination layer are updated.

In this way, when the layer is reduced in the storage device 100, the CM 110 determines the layer of the migration destination (after the relocation) based on the ranking recorded in the bit string B1 with respect to the FTRPE included in the sub pool to be reduced.

The CM 110 reflects the layers of the migration source and the migration destination accompanied by the relocation to the bit string B1 of the FTRPE to be relocated. Specifically, the CM 110 sets the layer of the migration source as “middle” and the layer of the migration destination as “high” in the bit string B1 corresponding to the FTRPE of “FTRPE No. 1.” Further, the CM 110 sets the layer of the migration source as “middle” and the layer of the migration destination as “low” in the bit string B1 corresponding to the FTRPE of “FTRPE No. 4.” In addition, the CM 110 sets the layer of the migration source as “middle” and the layer of the migration destination as “low” in the bit string B1 corresponding to the FTRPE of “FTRPE No. 8.”

The CM 110 notifies the relocation result of the FTRPE by the CM 110 to the management server 300 by transmitting the history information to the management server 300.

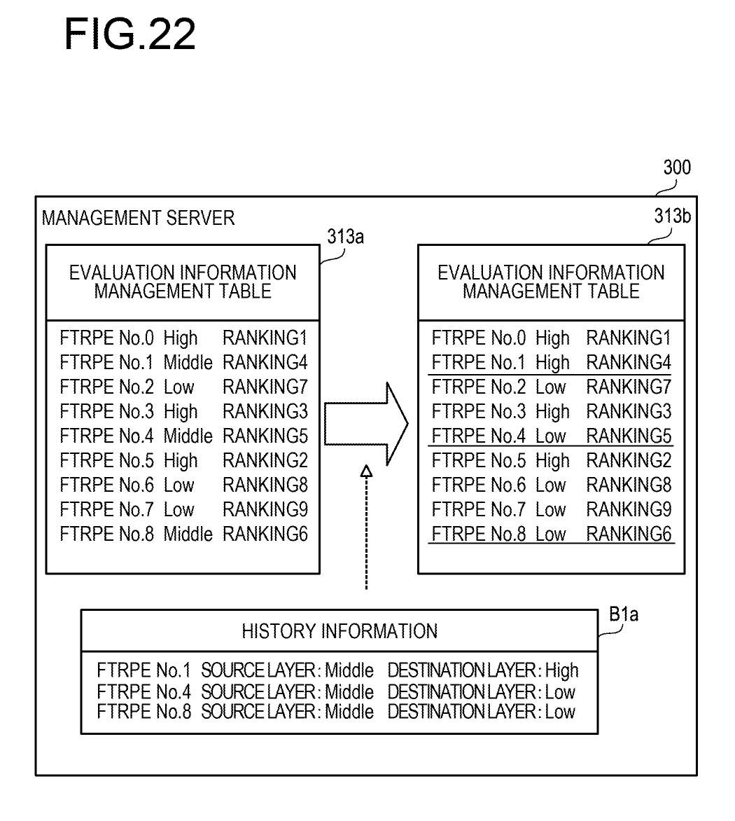

FIG. 22 is a diagram illustrating an updating example of an evaluation information management table based on history information. After the relocation illustrated in FIG. 21, the CM 110 transmits history information B1a to the management server 300. The history information B1a includes the following information. First, provided is the information of the “middle” layer of the migration source and the “high” layer of the migration destination of the FTRPE of “FTRPE No. 1.” Second, provided is the information of the “middle” layer of the migration source and the “low” layer of the migration destination of the FTRPE of “FTRPE No. 4.” Third, provided is the information of the “middle” layer of the migration source and the “low” layer of the migration destination of the FTRPE of “FTRPE No. 8.” Further, the CM 110 refers to the bit string B1 of each FTRPE to be relocated to generate the history information B1a.

In this case, the management server 300 holds an evaluation information management table 313a. The evaluation information management table 313a is evaluation information corresponding to the FTRPE before the relocation illustrated in FIG. 21. Upon receiving the history information B1a, the management server 300 updates the evaluation information management table 313a based on the history information B1a. Specifically, the management server 300 changes the affiliation layer of “FTRPE No. 1” from “middle” to “high” in the evaluation information management table 313a. Further, the management server 300 changes the affiliation layer of “FTRPE No. 4” from “middle” to “low.” In addition, the management server 300 changes the affiliation layer of “FTRPE No. 8” from “middle” to “low” in the evaluation information management table 313a. An evaluation information management table 313b is the result of applying the illustrated change to the evaluation information management table 313a. Further, the management server 300 compares the “FTRPE No.” included in the history information B1a and the layer of the migration source with each record of the evaluation information management table 313a to appropriately search the record of the FTRPE to be relocated by executing the shrink function. In addition, the management server 300 may acquire the information on the ranking of the FTRPE to be relocated from the CM 110 again and use the acquired ranking information for searching the record in the evaluation information management table 313a.

As a result, it possible to obtain the evaluation information management table 313b to which the FTRPE relocation result after execution of the shrink function by the storage device 100 is appropriately reflected in the management server 300. Therefore, the management server 300 may continue the operation of the AST by using the evaluation information management table 313b. Therefore, the CM 110 and the management server 300 may execute the shrink function without stopping the AST.

As described above, according to the information processing system according to the second embodiment, on the basis of the access frequency (for example, the value of TOPS) measured by the storage device 100, the relocation of the data in the virtual volume 109 of the storage device 100 is performed. As a result, the data included in the virtual volume 109 is located in the sub pool of an appropriate layer according to the access frequency of the corresponding data in the virtual volume 109.

As a result, the CM 110 may suppress the deterioration of the access performance by the data relocation at the time of changing the layer configuration. Specifically, the suppressing will be described below.

For example, the relocation of the FTRPE accompanied by the execution of the shrink function is executed by the function of the CM 110. In this case, it is also considered that the CM 110 executes the relocation of the FTRPE accompanied by the execution of the shrink function regardless of the access situation for each FTRPE. However, when the CM 110 relocates the FTRPE while not determining the information such as, for example, the access frequency for each FTRPE, an inappropriate relocation may be performed.

Specifically, it is considered that when the types of the memory devices are different (regardless of the evaluation result of the access situation), the CM 110 relocates the FTRPE so that the storage capacity of the memory device increases in the order of the online disk, the nearline disc, and the SSD. Alternatively, it is also considered that the FTRPEs are relocated only with the criterion of equalizing the storage capacities of the memory devices of the respective layers. In these methods, for example, when an intermediate (middle) layer is deleted, the FTRPE with the low access frequency may be relocated in the SSD. Further, on the contrary, the FTRPEs with the high access frequency are may be relocated in the nearline disk.

Such inappropriate relocation is a cause for lowering the access performance to the FTRPE with the high access frequency. Further, inappropriate relocation becomes the cause for the extra use of the memory area of the memory device having the high access performance by the FTRPE having the low access frequency. It is more efficient to suppress the inappropriate relocation in advance than to correct the inappropriate relocation by subsequent AST.

Therefore, the CM 110 determines the relocation destination of the FTRPE according to the execution of the shrink function according to the ranking depending on the access situation of each of the plurality of FTRPEs and relocates the FTRPE to the determined relocation destination. As a result, for example, the CM 110 may appropriately relocate the FTRPE having the relatively high access frequency among the FTRPEs to be relocated in the SSD and the FTRPE having the relatively low access frequency in the nearline disk, respectively. That is, for example, it is possible to suppress inappropriate relocation such as relocation of the FTRPE having the low access frequency in the SSD or relocation of the FTRPE having the high access frequency in the nearline disk. Thus, the CM 110 may suppress the deterioration of the access performance by the data relocation at the time of executing the shrink function.

In this case, by acquiring the ranking information from the management server 300, the CM 110 ends without calculating the ranking of each FTRPE by itself. Therefore, there is also an advantage that the load of the CM 110 may be reduced. In addition, the CM 110 may perform control matched with the AST by the management server 300 by using the evaluation result of the access situation in the AST by the management server 300 even in the processing of changing the layer configuration by the CM 110.

With respect to each FTRPE, the CM 110 holds the history information (the layer of the migration source/migration destination) of the AST by the bit string B1. In addition, like step S33 of FIG. 13, the management server 300 acquires the history information from the storage device 100 to update the affiliation destination (layer information) of the FTRPE in the evaluation information management table 313. That is, the evaluation processor 330 may appropriately reflect the layer of each FTRPE after the shrink function is executed to the evaluation information management table 313. In this way, the management server 300 appropriately takes over the evaluation information before the shrink function is executed even after the shrink function is executed.

Meanwhile, when the history information is not used, the AST is temporarily stopped when the shrink function is executed. The reason is that the layer of the migration source/migration destination and the evaluation result of the access frequency may not be correlated, and collection and evaluation processing of the access situation such as, for example, the access frequency is performed again.

Therefore, the CM 110 manages the history information by the bit string B1 and transmits the managed history information to the management server 300, thereby appropriately updating the evaluation information management table 313 of the management server 300. Therefore, the management server 300 may not create the evaluation information management table 313 again by temporarily stopping the AST. Therefore, the shrink function may be executed without stopping the AST. That is, even when the shrink function is executed, the operation by the AST may be continued without stopping the AST.

Processing functions of the devices (e.g., the storage control device 1, the information processing apparatus 3, the CM 110, and the management server 300) described in each embodiment may be implemented by a computer. In this case, the program describing a processing content of a function which each device needs to have is provided and is executed by the computer, and as a result, the processing function is implemented on the computer. The program describing the processing content may be recorded in a computer-readable recording medium (e.g., recording media 11 and 14).

For example, the computer-readable recording media 11 and 14 having the program recorded therein are distributed to distribute the program. Further, the program may be stored in another computer and the program may be distributed via the network. For example, the computer corresponding to the CM 110 may store (install) the distributed program in the memory device such as the RAM 112 or the flash memory 113, and read and execute the program from the memory device. Further, the computer corresponding to the management server 300 may store (install) the distributed program in the memory device such as the RAM 302 or the HDD 303 and read and execute the program from the memory device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a memory configured to store ranking information indicative of respective rankings of data blocks determined based on evaluation of an access situation of the data blocks, the data blocks being located in memory devices having different access performances and classified into layers depending on respective access performances of the memory devices; and
a processor coupled to the memory and the processor configured to:
determine, when a change of layer configuration accompanying a relocation of a first data block between layers is performed, a destination memory device to which the first data block is relocated based on the ranking information stored in the memory; and
relocate the first data block to the destination memory device.

2. The storage control device according to claim 1, wherein the change of layer configuration is removal of any one of the layers.

3. The storage control device according to claim 2, wherein
the layers include a fist layer having a first access performance, a second layer having a second access performance lower than the first access performance, and a third layer having a third access performance lower than the second access performance, and
the processor is configured to:
relocate, when removing the second layer, second data blocks located in the second layer to the first layer and third data blocks located in the second layer to the third layer, the rankings of the second data blocks being higher than the rankings of the third data blocks.

4. The storage control device according to claim 1, wherein the processor is configured to:
transmit information of respective access frequencies of the data blocks to an information processing apparatus; and
receive the ranking information from the information processing apparatus, the ranking information depending on evaluation of the access frequencies by the information processing apparatus.

5. The storage control device according to claim 4, wherein
the processor is configured to:
transmit history information to the information processing apparatus, the history information being indicative of a layer in which the first data block is located before the relocation and a layer in which the first data block is located after the relocation.

6. The storage control device according to claim 4, wherein
the processor is configured to:
receive a relocation instruction from the information processing apparatus, the relocation instruction instructing the storage control device to relocate the data blocks by automated storage tiering (AST) in accordance with the evaluation of the access frequencies.

7. An information processing system, comprising:
an information processing apparatus including:
a first memory; and
a first processor coupled to the first memory and the first processor configured to:
determine respective rankings of data blocks based on evaluation of respective access situations of the data blocks, the data blocks being located in memory devices having different access performances and classified into layers depending on respective access performances of the memory devices; and
a storage control device including:
a second memory; and
a second processor coupled to the second memory and the second processor configured to:
receive ranking information indicative of the respective rankings of the data blocks from the information processing apparatus;
determine, when a change of layer configuration accompanying a relocation of a first data block between layers is performed, a destination memory device to which the first data block is relocated based on the ranking information; and
relocate the first data block to the destination memory device.

8. The information processing system according to claim 7, wherein the change of layer configuration is removal of any one of the layers.

9. The information processing system according to claim 8, wherein
the layers include a fist layer having a first access performance, a second layer having a second access performance lower than the first access performance, and a third layer having a third access performance lower than the second access performance, and
the second processor is configured to:
relocate, when removing the second layer, second data blocks located in the second layer to the first layer and third data blocks located in the second layer to the third layer, the rankings of the second data blocks being higher than the rankings of the third data blocks.

10. The information processing system according to claim 7, wherein
the second processor is configured to:
transmit history information to the information processing apparatus, the history information being indicative of a layer in which the first data block is located before the relocation and a layer in which the first data block is located after the relocation, and
the first processor is configured to:
update correspondence information to indicate that the first data block is located on a layer in which the destination memory device is included, the correspondence information being indicative of layers on which the respective data blocks are located.

11. The information processing system according to claim 7, wherein
the first processor is configured to:
instruct the storage control device to relocate the data blocks by an automated storage tiering (AST) based on the evaluation of the respective access situations of the data blocks.

12. A non-transitory computer-readable recording medium having stored therein a program that causes a computer to execute a process, the process comprising:
receiving ranking information indicative of respective rankings of data blocks determined based on evaluation of an access situation of the data blocks, the data blocks being located in memory devices having different access performances and classified into layers depending on respective access performances of the memory devices;
determining, when a change of layer configuration accompanying a relocation of a first data block between layers is performed, a destination memory device to which the first data block is relocated based on the ranking information stored; and
relocating the first data block to the destination memory device.

13. The non-transitory computer-readable recording medium according to claim 12, wherein the change of layer configuration is removal of any one of the layers.

14. The non-transitory computer-readable recording medium according to claim 13, wherein
the layers include a fist layer having a first access performance, a second layer having a second access performance lower than the first access performance, and a third layer having a third access performance lower than the second access performance,
the process further comprising:
relocating, when removing the second layer, second data blocks located in the second layer to the first layer and third data blocks located in the second layer to the third layer, the rankings of the second data blocks being higher than the rankings of the third data blocks.

15. The non-transitory computer-readable recording medium according to claim 12, the process further comprising:
transmitting information of respective access frequencies of the data blocks to an information processing apparatus; and
receiving the ranking information from the information processing apparatus, the ranking information depending on evaluation of the access frequencies by the information processing apparatus.

16. The non-transitory computer-readable recording medium according to claim 15, the process further comprising:
transmitting history information to the information processing apparatus, the history information being indicative of a layer in which the first data block is located before the relocation and a layer in which the first data block is located after the relocation.

17. The non-transitory computer-readable recording medium according to claim 15, the process further comprising:
receiving a relocation instruction from the information processing apparatus, the relocation instruction instructing the computer to relocate the data blocks by automated storage tiering (AST) in accordance with the evaluation of the access frequencies.
